(19) United States
(12) Patent Application Publication
(10) Pub. No.: US 2019/0171609 A1
(43) Pub. Date: Jun. 6, 2019

(54) NON-DESTRUCTIVE OUTSIDE DEVICE ALERTS FOR MULTI-LANE I3C

(71) Applicant: QUALCOMM Incorporated, San Diego, CA (US)

(72) Inventors: Lalan Jee MISHRA, San Diego, CA (US); Radu PITIGOI-ARON, San Jose, CA (US); Richard Dominic WIETFELDT, San Diego, CA (US); Sharon GRAIF, Zichron Yakov (IL)

(21) Appl. No.: 16/162,536

(22) Filed: Oct. 17, 2018

Related U.S. Application Data
(60) Provisional application No. 62/594,956, filed on Dec. 5, 2017.
(60) Provisional application No. 62/630,229, filed on Feb. 13, 2018.

(51) Int. Cl. G06F 13/42; G06F 13/364; G06F 13/16; G06F 13/40

(52) U.S. Cl. CPC G06F 13/4282; G06F 13/364; G06F 2213/3604; G06F 13/4022; G06F 13/1684

(57) ABSTRACT

Systems, methods, and apparatus are described that enable a serial bus to be operated in one or more modes that employ additional wires for communicating data. A method for transmitting data over a serial bus having multiple data lanes includes providing a plurality of frames, each frame being configured to carry up to a maximum number of data bytes, transmitting a first frame over the serial bus, where the first frame is filled with first data bytes, notifying one or more devices of unavailability of an alert opportunity prior to transmitting the first frame, transmitting a second frame over the serial bus, where the first frame includes second data bytes less in number than the maximum number of data bytes, and notifying the one or more devices that the second frame provides an opportunity to launch an alert after transmission of the second data bytes.

### PRIORITY CLAIM

This application claims priority to and the benefit of U.S. Provisional Patent Application Ser. No. 62/594,956 filed in the U.S. Patent Office on Dec. 5, 2017, and of U.S. Provisional Patent Application Ser. No. 62/630,229 filed in the U.S. Patent Office on Feb. 13, 2018, the entire content of these applications being incorporated herein by reference as if fully set forth below in its entirety and for all applicable purposes.

### TECHNICAL FIELD

The present disclosure relates generally to an interface between processing circuits and peripheral devices and, more particularly, to expanding data communication throughput on a serial bus through the use of added data lanes.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, such as a multi-drop serial bus or a parallel bus. General-purpose serial interfaces are known in the industry, including the Inter-Integrated Circuit (I2C or I²C) serial bus and its derivatives and alternatives. Certain serial interface standards and protocols are defined by the Mobile Industry Processor Interface (MIPI) Alliance, including the I3C, system power management interface (SPMI), and the Radio Frequency Front-End (RFFE) interface standards and protocols.

The I2C bus is a serial single-ended computer bus that was intended for use in connecting low-speed peripherals to a processor. In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA), and a clock signal, which may be carried on a Serial Clock Line (SCL). Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. The protocols used on an I3C bus derive certain implementation aspects from the I2C protocol while offering higher data rates.

As applications have become more complex, demand for throughput over the serial bus can escalate and capacity continues to rise and there is a continuing demand for improved bus management techniques.

### SUMMARY

Certain aspects of the disclosure relate to systems, apparatus, methods and techniques that support bus width expansion on a dynamic basis. Certain aspects relate to methods for improving flow control on a serial bus when multiple data lanes are used to increase bus capacity, including when some devices may not be configured to support multiple data lanes.

In various aspects of the disclosure, a method for transmitting data over a serial bus having multiple data lanes includes providing a plurality of frames, each frame being configured to carry up to a maximum number of data bytes, transmitting a first frame over the serial bus, where the first frame is filled with first data bytes, notifying one or more devices of unavailability of an alert opportunity prior to transmitting the first frame, transmitting a second frame over the serial bus, where the first frame includes second data bytes less in number than the maximum number of data bytes, and notifying the one or more devices that the second frame provides an opportunity to launch an alert after transmission of the second data bytes.

In one aspect, notifying the one or more devices of unavailability of the alert opportunity includes transmitting a first command code over the serial bus prior to transmitting the first frame. Notifying the one or more devices that the second frame provides an opportunity to launch an alert may include transmitting a second command code over the serial bus prior to transmitting the first frame, the second command code being different from the first command code. The second command code may include determining a total number of bytes transmitted after the first command code has been transmitted, and transmitting the second command code when the total number of bytes transmitted after the first command code is at least equal to a configured maximum number of bytes between alert opportunities.

In various aspects of the disclosure, an apparatus has a bus interface configured to couple the apparatus to a multi-lane serial bus, a first control register configured with a fairness value, and I3C logic. The I3C logic may have a byte counter. The I3C logic may be configured to cause the bus interface to transmit a first command code over the multi-lane serial bus, transmit a plurality of frames over the multi-lane serial bus, and transmit a second command code over the multi-lane serial bus after the byte counter indicates that a number of bytes transmitted since transmission of the first command code is at least equal to the fairness value. The first command code may be configured to restrain one or more devices coupled to the multi-lane serial bus from launching an alert over the serial bus. The second command code may be configured to notify the one or more devices of an opportunity to launch an alert over the serial bus.

In various aspects of the disclosure, an apparatus includes a serial bus, means for providing a plurality of frames, each frame being configured to carry up to a maximum number of data bytes, means for transmitting frames over the serial bus, where a first frame transmitted over the serial bus is filled with first data bytes and a second frame transmitted over the serial bus includes second data bytes less in number than the maximum number of data bytes, means for notifying one or more devices of unavailability of an alert opportunity prior to transmitting the first frame, and means for notifying the one or more devices that the second frame provides an opportunity to launch an alert after transmission of the second data bytes.

In various aspects of the disclosure, a processor-readable storage medium stores data and instructions executable by a processor. The instructions may cause the processor to provide a plurality of frames, each frame being configured to carry up to a maximum number of data bytes, transmit a first frame over the serial bus, where the first frame is filled with first data bytes, and transmit a second frame over a serial bus. The first frame may include second data bytes less in number than the maximum number of data bytes, and the first frame and the second frame have a common duration.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates a system architecture for an apparatus employing a data link between IC devices.

FIG. 4 includes a timing diagram that illustrates signaling on a serial bus when the serial bus is operated in a single data rate (SDR) mode of operation defined by I3C specifications.

FIG. 5 is a timing diagram 500 that illustrates an example of a transmission in an I3C high data rate (HDR) mode, where data is transmitted at double data rate (DDR).

FIG. 6 illustrates an example of signaling transmitted on the Data wire and Clock wire of a serial bus to initiate certain mode changes.

FIG. 7 illustrates a serial bus in which more than two connectors or wires may be available for timeshared communication between devices.

FIG. 8 relates to an HDR-DDR mode of operation in which data is clocked on both edges of each clock pulse in the clock signal.

FIG. 9 illustrates datagram structures that may be received during a device read over an I3C serial bus operated in an SDR mode in accordance with certain aspects disclosed herein.

FIG. 10 illustrates first examples of datagram structures that may be transmitted during a device write where parity is transmitted with each byte of data in accordance with certain aspects disclosed herein.

FIG. 11 illustrates second examples of datagram structures that may be transmitted during a device write where parity is transmitted with each byte of data in accordance with certain aspects disclosed herein.

FIGS. 12 and 13 illustrate multi-lane read frames that provide alert opportunities or windows in accordance with certain aspects disclosed herein.

FIGS. 14 and 15 illustrate multi-lane write frames, including frames that provide alert opportunities or windows in accordance with certain aspects disclosed herein.

FIG. 16 illustrates the operation of multi-lane command codes in accordance with certain aspects disclosed herein.

FIG. 17 illustrates a system that includes one or more devices that may be adapted in accordance with certain aspects disclosed herein.

FIG. 18 illustrates striped datagram structures that can carry filler data in accordance with certain aspects disclosed herein.

FIGS. 19 and 20 illustrate the use of filler data in multi-lane write frames in accordance with certain aspects disclosed herein.

FIGS. 21 and 22 illustrate the use of filler data in multi-lane read frames in accordance with certain aspects disclosed herein.

FIG. 23 illustrates datagram structures that can carry filler data in parallel with payload data in accordance with certain aspects disclosed herein.

FIG. 24 is a block diagram illustrating an example of an apparatus employing a processing circuit that may be adapted according to certain aspects disclosed herein.

FIG. 25 is a flowchart illustrating a process that may be performed at a sending device coupled to a serial bus in accordance with certain aspects disclosed herein.

FIG. 26 illustrates a hardware implementation for a transmitting apparatus adapted to respond to support multi-lane operation of a serial bus in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a serial bus to connect an application processor or other host device with modems and other peripherals. The serial bus may be operated in accordance with specifications and protocols defined by a standards body that define timing relationships between signals and transmissions. Certain aspects disclosed herein relate to systems, apparatus, methods and techniques that provide a mechanism that can be used on an I3C bus to dynamically extend the bus width and thereby improve bandwidth and/or throughput. When the bus width is extended, alert opportunities may be employed that improve link performance.

In one example, a method performed at a transmitting device coupled to a serial bus includes providing a plurality of frames, each frame being configured to carry up to a maximum number of data bytes, transmitting a first frame over the serial bus, where the first frame is filled with first data bytes, notifying one or more devices of unavailability of an alert opportunity prior to transmitting the first frame, transmitting a second frame over the serial bus, where the first frame includes second data bytes less in number than the maximum number of data bytes, and notifying the one or more devices that the second frame provides an opportunity to launch an alert after transmission of the second data bytes.

### Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

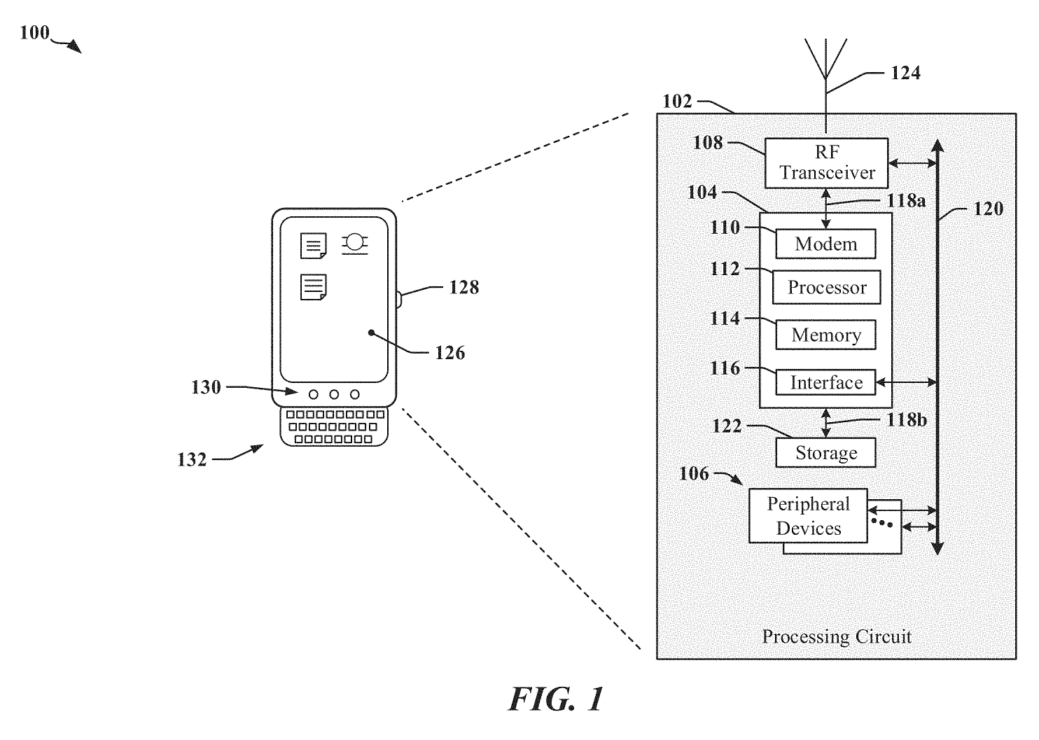

FIG. 1 illustrates an example of an apparatus 100 that may employ a data communication bus. The apparatus 100 may include a processing circuit 102 having multiple circuits or devices 104, 106 and/or 108, which may be implemented in an SoC in some instances. In one example, the apparatus 100 may be a communication device and the processing circuit 102 may include a processing device provided in an ASIC 104, with one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

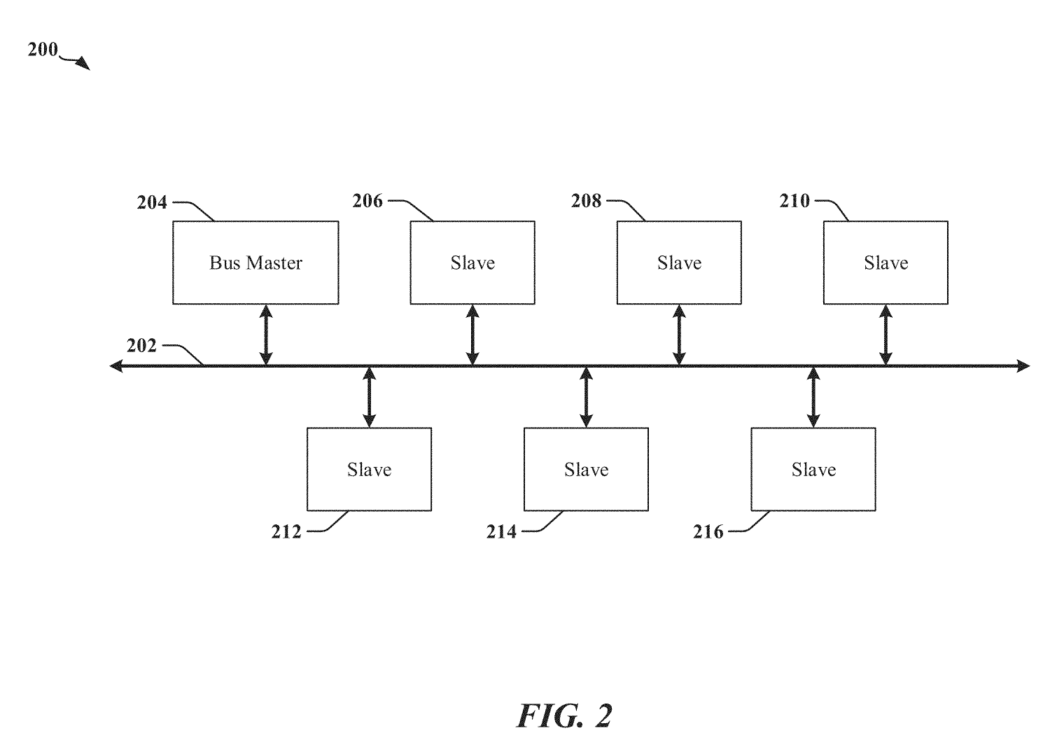

FIG. 2 illustrates a system 200 in which multiple devices 204, 206, 208, 210, 212, 214 and 216 are connected using a serial bus 202. In one example, the devices 204, 206, 208, 210, 212, 214 and 216 may be adapted or configured to communicate over the serial bus 202 in accordance with an I3C protocol. In some instances, one or more of the devices 204, 206, 208, 210, 212, 214 and 216 may alternatively or additionally communicate using other protocols, including an I2C protocol, for example.

Communication over the serial bus 202 may be controlled by a master device 204. In one mode of operation, the master device 204 may be configured to provide a clock signal that controls timing of a data signal. In another mode of operation, two or more of the devices 204, 206, 208, 210, 212, 214 and 216 may be configured to exchange data encoded in symbols, where timing information is embedded in the transmission of the symbols.

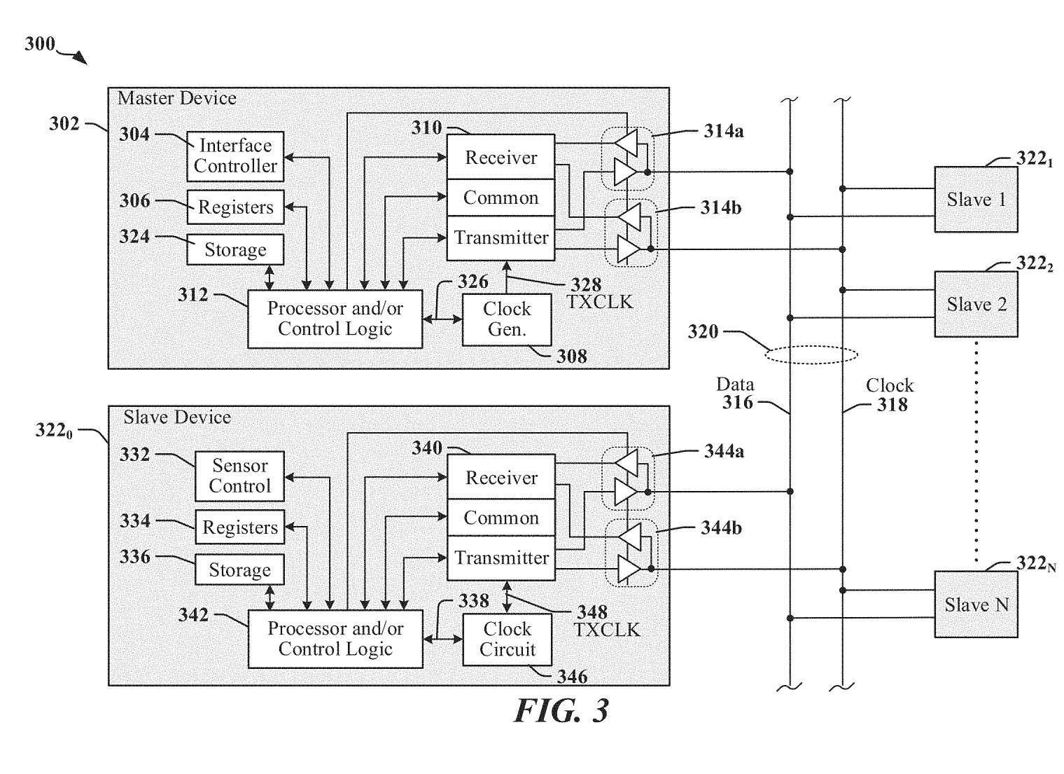

FIG. 3 illustrates certain aspects of an apparatus 300 that includes multiple devices 302, and 322₀-322_{N} coupled to a serial bus 320. The devices 302 and 322₀-322_{N} may be implemented in one or more semiconductor IC devices, such as an application processor, SoC or ASIC. In various implementations the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communications between devices 302 and 322₀-322_{N} over the serial bus 320 is controlled by a bus master 302. Certain types of bus can support multiple bus master devices 302.

In one example, a bus master device 302 may include an interface controller 304 that manages access to the serial bus, configures dynamic addresses for slave devices 322₀-322_{N} and/or generates a clock signal 328 to be transmitted on a clock line 318 of the serial bus 320. The bus master device 302 may include configuration registers 306 or other storage 324, and other control logic 312 configured to handle protocols and/or higher level functions. The control logic 312 may include a processing circuit having a processing device such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clock signals 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit having a processing device such as a state machine, sequencer, signal processor or general-purpose processor. The transceiver 340 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. The clock signal 348 may be derived from a signal received from the clock line 318. Other timing clock signals 338 may be used by the control logic 342 and other functions, circuits or modules.

The serial bus 320 may be operated in accordance with RFFE, I2C, I3C, SPMI, or other protocol. In some instances, two or more devices 302, 322₀-322_{N} may be configured to operate as a bus master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, data is transmitted on a data line 316 of the serial bus 320 based on timing information provided in a clock signal transmitted on the clock line 318 of the serial bus 320. In some instances, data may be encoded in the signaling state, or transitions in signaling state of both the data line 316 and the clock line 318.

Data Transfers Over an I3C Serial Bus

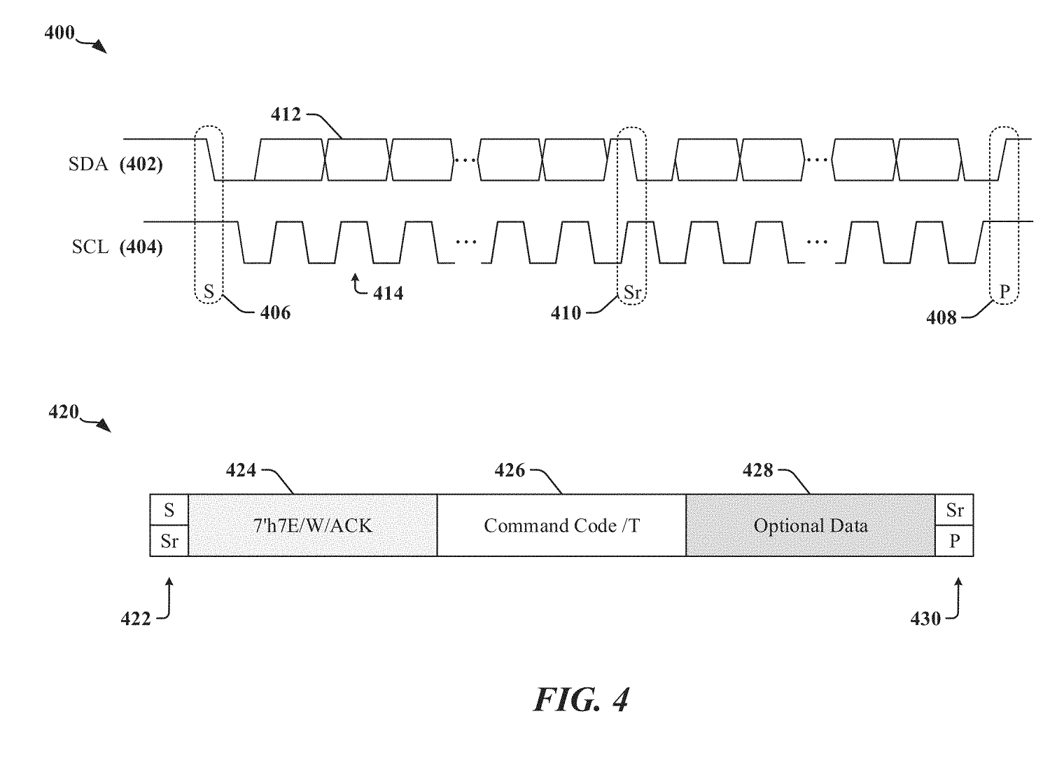

FIG. 4 includes a timing diagram 400 that illustrates signaling on a serial bus when the serial bus is operated in a single data rate (SDR) mode of operation defined by I3C specifications. Data transmitted on a first wire (the Data wire 402) of the serial bus may be captured using a clock signal transmitted on a second wire (the Clock wire 404) of the serial bus. During data transmission, the signaling state 412 of the Data wire 402 is expected to remain constant for the duration of the pulses 414 when the Clock wire 404 is at a high voltage level. Transitions on the Data wire 402 when the Clock wire 404 is at the high voltage level indicate a START condition 406, a STOP condition 408 or a repeated START 410.

On serial bus operated in accordance with I3C protocols, a START condition 406 is defined to permit the current bus master to signal that data is to be transmitted. The START condition 406 occurs when the Data wire 402 transitions from high to low while the Clock wire 404 is high. The bus master may signal completion and/or termination of a transmission using a STOP condition 408. The STOP condition 408 is indicated when the Data wire 402 transitions from low to high while the Clock wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the Data wire 402 transitions from high to low while the Clock wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined code 424 indicating that a command code 426 is to follow. The command code 426 may, for example, cause the serial bus to transition to a desired mode of operation. In some instances, data 428 may be transmitted. The command code transmission 420 may be followed by a terminator 430 that may be a STOP condition 408 or a repeated START 410.

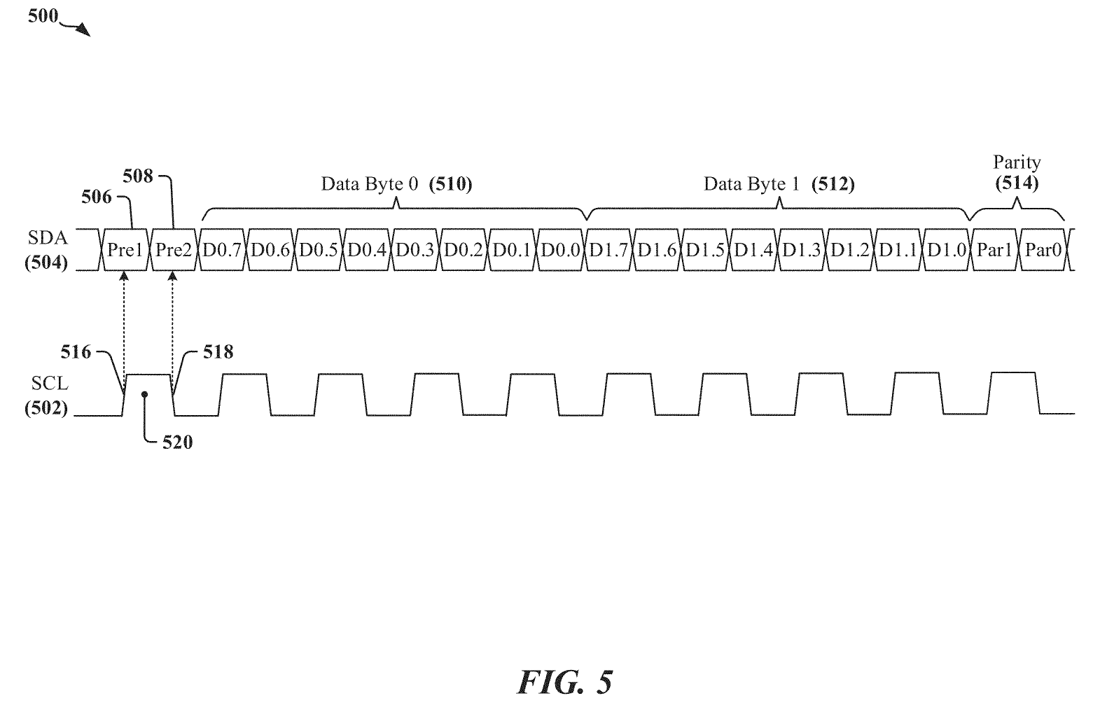

Certain serial bus interfaces support signaling schemes that provide higher data rates. In one example, I3C specifications define multiple high data rate (HDR) modes, including a high data rate, double data rate (HDR-DDR) mode in which data is transferred at both the rising edge and the falling edge of the clock signal. FIG. 5 is a timing diagram 500 that illustrates an example of a transmission in an I3C HDR-DDR mode, in which data transmitted on the Data wire 504 is synchronized to a clock signal transmitted on the Clock wire 502. The clock signal includes pulses 520 that are defined by a rising edge 516 and a falling edge. A master device transmits the clock signal on the Clock wire 502, regardless of the direction of flow of data over the serial bus. A transmitter outputs one bit of data at each edge 516, 518 of the clock signal. A receiver captures one bit of data based on the timing of each edge 516, 518 of the clock signal.

Certain other characteristics of an I3C HDR-DDR mode transmission are illustrated in the timing diagram 500 of FIG. 5. According to certain I3C specifications, data transferred in HDR-DDR mode is organized in words. A word generally includes 16 payload bits, organized as two 8-bit bytes 510, 512, preceded by two preamble bits 506, 508 and followed by two parity bits 514, for a total of 20 bits that are transferred on the edges of 10 clock pulses. The integrity of the transmission may be protected by the transmission of the parity bits 514.

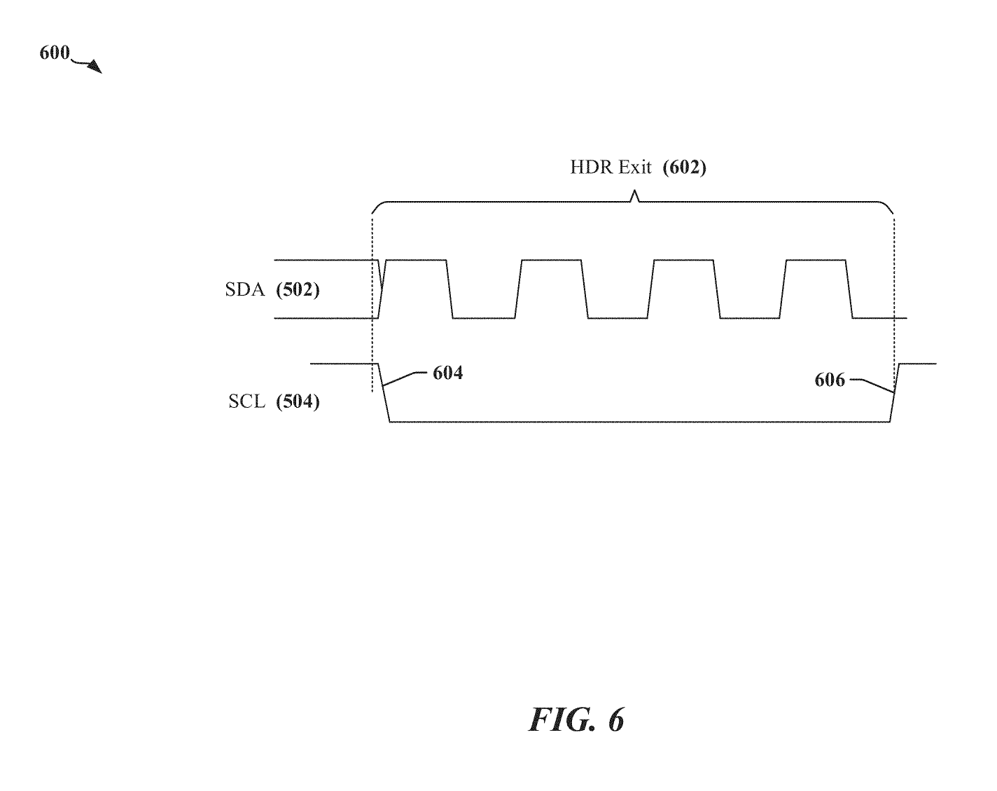

FIG. 6 illustrates an example of signaling 600 transmitted on the Data wire 504 and Clock wire 502 to initiate certain mode changes. The signaling 600 is defined by I3C protocols for use in initiating restart, exit and/or break from I3C HDR modes of communication. The signaling 600 includes an HDR Exit 602 that may be used to cause an HDR break or exit. The HDR Exit 602 commences with a falling edge 604 on the Clock wire 502 and ends with a rising edge 606 on the Clock wire 502. While the Clock wire 502 is in low signaling state, four pulses are transmitted on the Data wire 504. I2C devices ignore the Data wire 504 when no pulses are provided on the Clock wire 502.

In another HDR mode, I3C specifications define a ternary encoding scheme in which transmission of a clock signal is suspended and data is encoded in symbols that define signal states transmitted over both the clock line and the data line. Clock information is encoded by ensuring that a transition in signaling state occurs at each transition between two consecutive symbols.

Multi-Lane Serial Bus

Various examples discussed herein may be based on, or refer to a MIPI-defined I3C bus, and to HDR-DDR and HDR Ternary modes. The use of MIPI I3C HDR-DDR mode and other I3C modes are referenced as examples only, and the principles disclosed herein are applicable in other contexts.

In some instances, enhanced capability and speed increases may be obtained by the addition of one or more supplementary data lines, enabling a change in the coding base to higher numbers. For example, in addition to a two-wire bus, many I2C legacy systems use one or more dedicated interrupt lines between a master device and one or more slave devices. These dedicated interrupt lines may be repurposed for data transmission (along with the two-wire bus) when the master device switches from a predefined base protocol (e.g., I2C) to a second protocol in which data can be transmitted on multiple lines and/or in data symbols that are encoded across the two-wire bus and one or more dedicated interrupt lines.

In one example, data may be encoded using transition encoding to obtain symbols for transmission over a two-line serial bus and one or more additional lines. When a single additional line is available, the second protocol can transmit 8 symbols over 3 wires (as compared to only 4 symbols over 2 wires), thus allowing for coding in base 7.

In another example, when a two-line I3C bus operated in SDR mode or HDR-DDR mode can be extended with one or more additional lines, data can be transmitted on the additional lines in accordance with the timing provided by a clock signal transmitted on the Clock line.

For the purpose of facilitating description, the term data lane may be used to refer to any data line or additional data line when more than two wires or lines are available for data transmission.

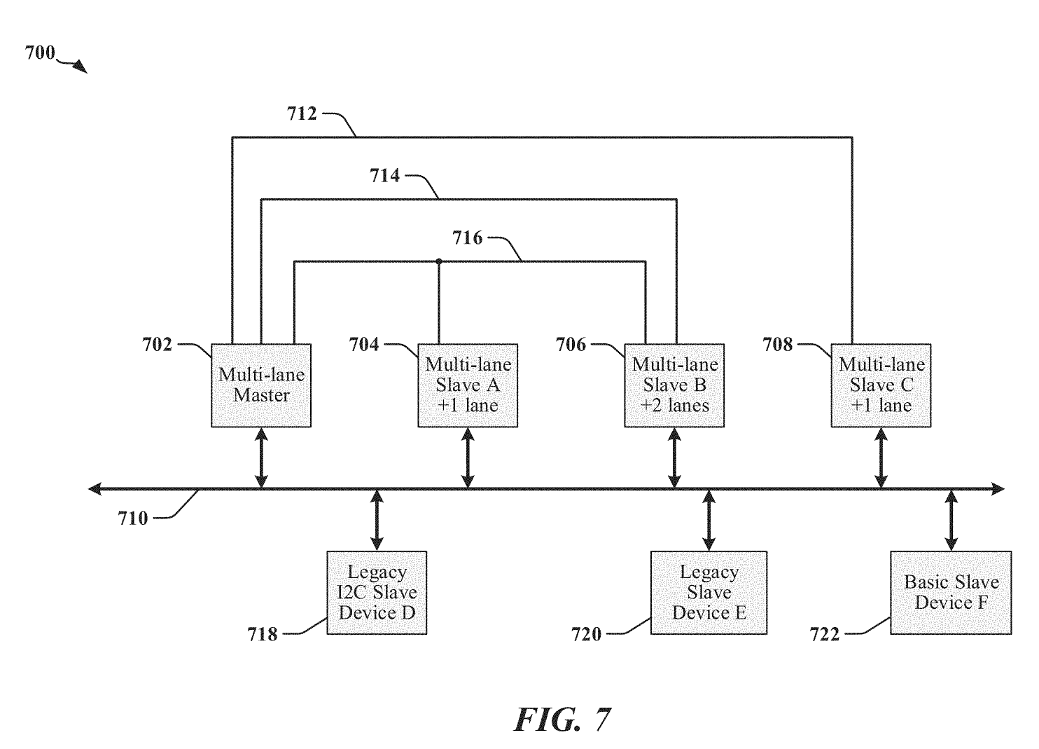

FIG. 7 illustrates a system 700 in which more than two connectors or wires may be available for timeshared communication between devices 702, 704, 706, and/or 708. Devices 702, 704, 706, and/or 708 that can support communication over an expanded serial bus that includes additional wires may be referred to as multi-wire devices or multi-lane devices. Note that the terms “connector”, “wire”, and “line” may be interchangeably used herein to refer to an electrically conductive path. In some instances, a “connector”, “wire”, and “line” may apply to an optically conductive path. In addition to the common lines of a 2-wire I3C bus 710, additional connectors or wires 712, 714, and/or 716 may be employed to couple a Multi-lane master device 702 to one or more Multi-lane slave devices 704, 706, and/or 708 separately from the I3C bus 710. In one example, one Multi-lane slave device 708 may be connected to the Multi-lane master device 702 using a single, dedicated additional connector or wire 712. In another example, one Multi-lane slave device 704 may be connected to the Multi-lane master device 702 using a single, shared additional connector or wire 716. In another example, one Multi-lane slave device 706 may be connected to the Multi-lane master device 702 using two or more dedicated and/or shared additional connectors or wires 714 and 716. The number, type and arrangement of additional connectors or wires 712, 714, and/or 716 can be selected to balance bandwidth and power consumption for communications between Multi-lane devices 702, 704, 706, and/or 708. In some instances, the additional connectors may include optical or other types of connectors.

According to certain aspects, any number of wires that is greater than two physical wires can be used in an I3C interface. Two of the wires may be common wires, such as the Clock line 316 and Data line 318 wires are used for communicating with legacy devices 718, 720 and/or I3C devices 722 that are not configured for multi-wire operation. Legacy devices 718, 720 may include I2C device 718, an I3C device 722, or another type of device that uses a two-wire protocol compatible with other devices 702, 704, 706, 708, 718, 720, 722 coupled to the shared I3C bus 710.

Bus management messages may be included in shared bus management protocols implemented on the Multi-lane-capable bus client devices 702, 704, 706, and 708. Bus management messages may be transferred between Multi-lane-capable devices 702, 704, 706, and 708 using the two-wire shared I3C bus 710. Bus management messages may include address arbitration commands and/or messages, commands and/or messages related to data transport mode entry and exit, commands and/or messages used in the exchange of configuration data including, for example, messages identifying supported protocols, number and allocation of available physical wires, and commands and/or messages that are to negotiate or select a mode of communications.

As illustrated in FIG. 7, different legacy client devices 718 and 720 and I3C devices 722 that have more basic signaling capabilities may be supported by the I3C interface. The devices 702, 704, 706, 708, 718, 720, 722 coupled to the shared I3C bus 710 are compatible with at least one common mode of communication (e.g., predefined base protocol over the two-wire shared I3C bus 710). In one example the predefined base protocol (e.g., lowest common denominator protocol), may support an I2C mode of communication. In this latter example, each of the devices 702, 704, 706, 708, 718, 720, 722 may be adapted to at least recognize start and stop conditions defined by the predefined base protocol.

Two or more devices 702, 704, 706, 708, 720, and/or 722 may communicate using a second protocol (e.g., I3C SDR, I3C HDR-DDR, I3C HDR-Ternary) that is not supported by some of the other devices coupled to the shared I3C bus 710. The two or more devices 702, 704, 706, 708, 718, 720, 722 may identify capabilities of the other devices using the predefined base protocol (e.g., an I2C protocol), after an I3C exchange is initiated, and/or through signaling on one or more additional connectors or wires 712, 714 and/or 716. In at least some instances, the configuration of devices coupled to the shared I3C bus 710 may be predefined in the devices 702, 704, 706, 708, 718, 720, 722.

The additional connectors or wires 712, 714 and/or 716 may include multipurpose, reconfigurable connectors, wires, or lines that connect two or more of the Multi-lane devices 702, 704, 706, 708. The additional connectors or wires 712, 714 and/or 716 may include repurposed connections that may otherwise provide inter-processor communications capabilities including, for example interrupts, messaging and/or communications related to events. In some instances, the additional connectors or wires 712, 714 and/or 716 may be provided by design. In one example, the predefined base protocol may utilize the additional connectors or wires 712, 714 and/or 716 for sending interrupts from the slave devices to the master device. In the second protocol, the additional connectors or wires 712, 714 and/or 716 may be repurposed to transmit data in combination with the two-wire shared I3C bus 710.

Master and Slave roles are typically interchangeable between Multi-lane devices 702, 704, 706, 708, and FIG. 5 relates to a single interaction between two or more of the devices 702, 704, 706, 708, and/or 722. As illustrated, the current master device 702 can support extended communication capabilities with the other Multi-lane devices 704, 706, 708, using a combination of the additional connectors or wires 712, 714, and 716. The master Multi-lane device 702 is connected to two slave devices 704 and 708 using a single additional connector or wire 716 and 712, respectively. The master Multi-lane device 702 is connected to one slave device 706 using a pair of additional wires 714 and 716. Accordingly, the master Multi-lane device 702 may be configured to select a number of wires for communication based on the capabilities of all slave devices 704, 706, and/or 708 that are involved in a transaction. For example, the Multi-lane master device 702 may send data to the first Multi-lane slave device B 706 using the two-wire shared I3C bus 710 plus both repurposed wires 714 and 716. Additionally, the Multi-lane master device 702 may send data to the second Multi-lane slave device A 704 using the two-wire shared I3C bus 710 plus a first repurposed wire 716.

In a Multi-lane example involving I3C SDR or I3C HDR-DDR, data may be transmitted over two connectors, wires or lines 316, 318, 712, 714, and/or 716 when one additional wire is available, and data may be transmitted over 4 connectors, wires or lines 316, 318, 712, 714, and/or 716 when 3 additional wires are available, and so on.

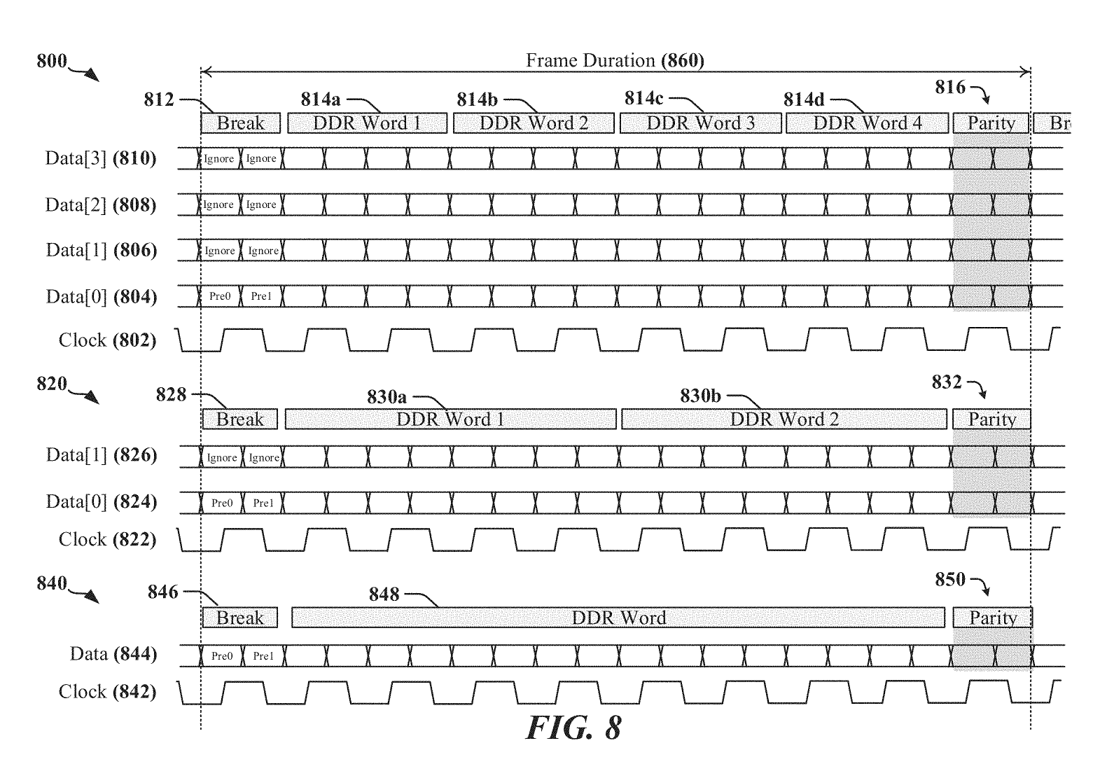

FIG. 8 relates to an HDR-DDR mode of operation in which data is clocked on both edges of each clock pulse in the clock signal. FIG. 8 illustrates examples 800, 820, 840 of data transmission data over an I3C serial bus operated in HDR_DDR mode when two or more devices can be coupled to additional connectors, lines or wires 712, 714, and/or 716. In each example, 800, 820, 840 a common transaction and/or frame duration 860 is maintained regardless of the number of additional wires used. For example, a transaction that involves the use of 2 data wires and one clock wire can communicate twice as many bits as a transaction that uses 1 data wire and one clock signal. The additional bits include payload data bits, parity bits, other protocol bits, and/or other information. For example, parity bits 816, 832, 850 are transmitted concurrently with a single clock pulse on each data wire. The parity bits 816, 832, 850 are transmitted in the same time-slot (relative to the start of the transaction or frame) in each example 800, 820, 840. The maintenance of a common transaction and/or frame duration 860 can maintain a constant separation between break points (e.g. T-bits), and devices coupled to the bus and configured for a conventional two-wire mode of operation remain unaware of the use of additional wires. The common transaction and/or frame duration 860 may effectively define a cadence for bus operations.

In the first example 840, no additional wires are used and communication proceeds using two wires (Clock and one Data wire). A serialized 16-bit data word 848 may be transmitted after two preamble bits and breaking point 846. Two parity bits 850 may be transmitted after the data word 848. In a second example 820, one additional wire is used and communication proceeds using three wires (Clock and two Data wires). Two 16-bit data words 830a, 830b may be transmitted after two preamble bits and breaking point 828. Two parity bits 850 may be transmitted on each data wire after the data words 830a, 830b, providing a total of four parity bits. In the example, the data words 830a, 830b are transmitted in a striped mode, whereby a first data word 830a is completely transmitted in two-bit nibbles on the two data wires before the second data word 830b is transmitted. In other implementations, data words may be transmitted in parallel on the two data wires. In another example 800, three additional wires are used and communication proceeds using five wires (Clock and four Data wires). Four data words 814a, 814b, 814c and 814d may be transmitted after two preamble bits and breaking point 812. In the example, the data words 814a, 814b, 814c, 814d are transmitted in a striped mode, whereby a first data word 814a is completely transmitted in four-bit nibbles on the four data wires before the second data word 814b is transmitted. In other implementations, data words may be transmitted in parallel on the four data wires. The preamble bits are typically transmitted on the primary data wire of the two-wire I3C bus, and signaling state of the additional connectors, lines or wires 712, 714, and/or 716 may be ignored by a receiver.

The examples 800, 820, 840 illustrated in FIG. 8 provide a number of parity bits that can be used to provide enhance error detection and correction capabilities. In one example, the parity bits transmitted on the data wire of the on the base 2-wire I3C are preserved and configured in accordance with I3C specifications. For example, a 2-bit cyclic redundancy check for the preceding data words 848, 830a-830b, 814a-814d may be transmitted in the two-bit field designated by the I3C Specifications. In another example, a two-bit CRC can be transmitted on each additional data lane, calculated from the bits transmitted over the corresponding additional data lane. In another example, a CRC sized according to the number of available parity bits may be calculated from the preceding data words 848, 830a-830b, 814a-814d bits. For example, a two-bit CRC may be transmitted when no additional lines are available, a four-bit CRC may be transmitted when one additional line is available, and an eight-bit CRC may be transmitted when three additional lines are available. In another example, the parity bits may be used to implement a block-parity error detection and correction scheme.

As illustrated in certain of the examples, a multilane (ML) extension of an I3C bus may be implemented to provide increased data throughput, while keeping the I3C Interface bus management procedures. I3C frame settings are preserved to provide break points 812, 828, 846, 812, 828, 846 at the expected time defined by the conventional I3C specifications. The ML version of the I3C interface permits devices of single, dual or quad data lanes to be connected on the same two-wire base lanes. ML-capable devices can be enabled a priori, with available data lanes enabled or supported.

Frame Structures for a Multi-Lane Serial Bus

In accordance with certain aspects disclosed herein, the arrangement of data transmitted in frames over a multi-lane serial bus may be configured based on protocol or application requirements. For example, bytes of data may be assigned to specific data lanes according to source, such that an individual line or group of lines may operate as defined channel. In another example, and as illustrated in FIG. 8, data bytes may be transmitted in a striped mode, whereby a first data byte is transmitted in nibbles spread across all available lines of a multi-lane bus.

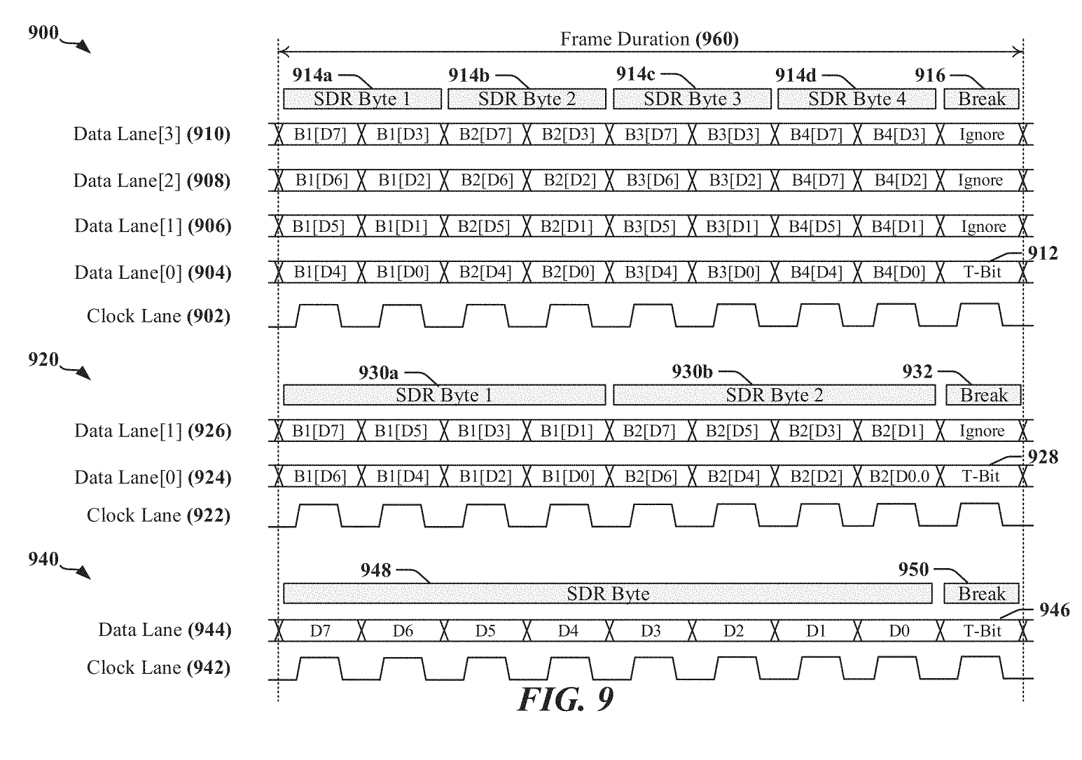

Different allocations of bits in a multi-byte frame transmitted over a multi-lane serial bus may be selected when data is striped across multiple lines. FIG. 9 illustrates datagram structures 900, 920, 940 that may be received during a device read. The datagram structures 900, 920, 940 of FIG. 9 correspond to the datagram structures illustrated in the examples 1300, 820, 840 of FIG. 8. The allocation of bits in the multi-lane datagram structures 900, 920 of FIG. 9 is different from the allocation of bits in the corresponding datagram structures illustrated in the examples 800, 820 of FIG. 8.

FIG. 9 illustrates data exchanges over an I3C serial bus operated in an SDR mode when two or more devices can be coupled to additional connectors, lines or wires. In each datagram structure 900, 920, 940 a common transaction and/or frame duration 960 is maintained regardless of the number of additional lines used. For example, a transaction that involves the use of 2 data lanes and one clock line can communicate twice as many bits as a transaction that uses 1 data lane and one clock signal. Additional bits may be transmitted, including payload data bits, parity bits, control bits, command bits, other protocol-defined bits and/or other information. In some implementations, devices coupled to the bus and configured for a conventional two-line mode of operation remain unaware of the use of additional lines. In some instances, a parity bit may be transmitted on each line concurrently with a single clock pulse. In some implementations, a common transaction and/or frame duration 960 can be provided using break points 916, 932, 950 to separate frames. The break points 916, 932, 950 may be defined by transmission of T-bits 912, 928, 946 in at least one data lane. The common transaction and/or frame duration 960 may define a cadence for bus operations.

In the first datagram structure 940, no additional lines are used and communication proceeds using two lines (clock line 942 and one data lane 944). A serialized data byte 948 may be terminated at a breaking point 950 defined by a T-bit 946 transmitted on the data lane 944.

In a second datagram structure 920, one additional line is used and communication proceeds using three lines (clock line 922 and two data lanes 924, 926). Two data bytes 930a, 930b may be terminated at a breaking point 932 defined by a T-bit 928 transmitted on one of the data lanes 926, 924. In the example, the data bytes 930a, 930b are transmitted in a striped mode, whereby a first data byte 930a is completely transmitted in two-bit nibbles on the two data lanes before the second data byte 930b is transmitted. In other implementations, data bytes may be transmitted in parallel on the two data lanes.

In another datagram structure 900, three additional lines are used and communication proceeds using five lines (clock line 902 and four data lanes 904, 906, 908, 910). Four data bytes 914a, 914b, 914c and 914d may be terminated at a breaking point 916 defined by a T-bit 912 transmitted on one of the data lanes 904, 906, 908, 910. In the example, the data bytes 914a, 914b, 914c, 914d are transmitted in a striped mode, whereby a first data byte 914a is completely transmitted in four-bit nibbles on the four data lanes before the second data byte 914b is transmitted. In other implementations, data bytes may be transmitted in parallel on the four data lanes. In each of the datagram structures 900, 920, 940 in FIG. 9, data is clocked on one edge of each clock pulse in the clock signal transmitted on the clock line 902, 922, 942, in accordance with I3C SDR protocols.

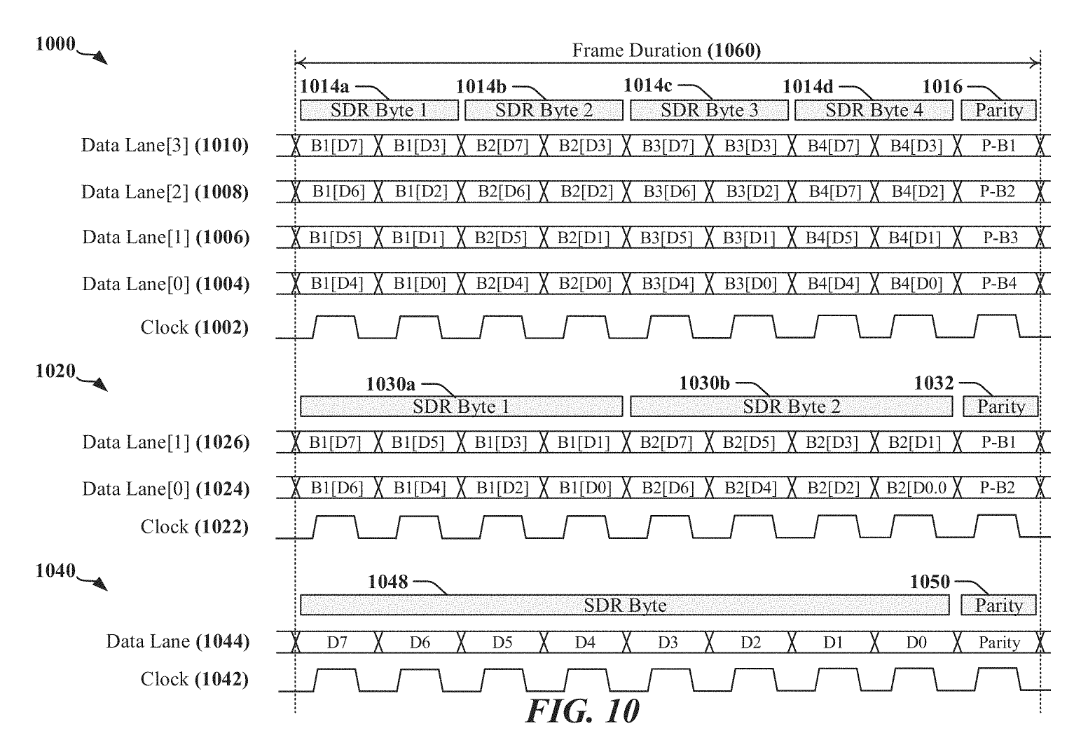

FIG. 10 illustrates examples of datagram structures 1000, 1020, 1040 that may be transmitted during a device write where parity is transmitted with each byte of data. FIG. 10 illustrates data exchanges over an I3C serial bus operated in an SDR mode when two or more devices can be coupled to additional connectors, lines or wires. In each datagram structure 1000, 1020, 1040, a common transaction and/or frame duration 1060 is maintained regardless of the number of additional lines used. For example, a transaction that involves the use of 2 data lanes and one clock line can communicate twice as many bits as a transaction that uses 1 data lane and one clock signal. In the examples illustrated in FIG. 10, a parity bit may be transmitted on each data lane concurrently and in accordance with a common clock pulse. Parity transmissions 1016, 1032, 1050 occurs after transmission of data bytes 1014a-1014d, 1030a-1030b, 1048. Allocation of parity bits to data lanes may be configured based on application needs and/or circuit design.

In the first datagram structure 1040, no additional lines are used and communication proceeds using two lines (clock line 1042 and one data lane 1044). A serialized data byte 1048 may be terminated after a parity transmission 1016 of a parity bit on the data lane 1044.

In a second datagram structure 1020, one additional line is used and communication proceeds using three lines (clock line 1022 and two data lanes 1024, 1026). Two data bytes 1030a, 1030b may be terminated after a parity transmission 1032 including up to two parity bits transmitted on the data lanes 1026, 1024. In the example, the data bytes 1030a, 1030b are transmitted in a striped mode, whereby a first data byte 1030a is completely transmitted in two-bit nibbles on the two data lanes before the second data byte 1030b is transmitted. In other implementations, data bytes may be transmitted in parallel on the two data lanes.

In a third datagram structure 1000, three additional lines are used and communication proceeds using five lines (clock line 1002 and four data lanes 1004, 1006, 1008, 1010). Four data bytes 1014a, 1014b, 1014c and 1014d may be terminated after a parity transmission 1050 including up to four parity bits transmitted on the data lanes 1004, 1006, 1008, 1010. In the example, the data bytes 1014a, 1014b, 1014c, 1014d are transmitted in a striped mode, whereby a first data byte 1014a is completely transmitted in four-bit nibbles on the four data lanes before the second data byte 1014b is transmitted. In other implementations, data bytes may be transmitted in parallel on the four data lanes. In each of the datagram structures 1000, 1020, 1040 in FIG. 10, data is clocked on one edge of each clock pulse in the clock signal transmitted on the clock line 1002, 1022, 1042, in accordance with I3C SDR protocols.

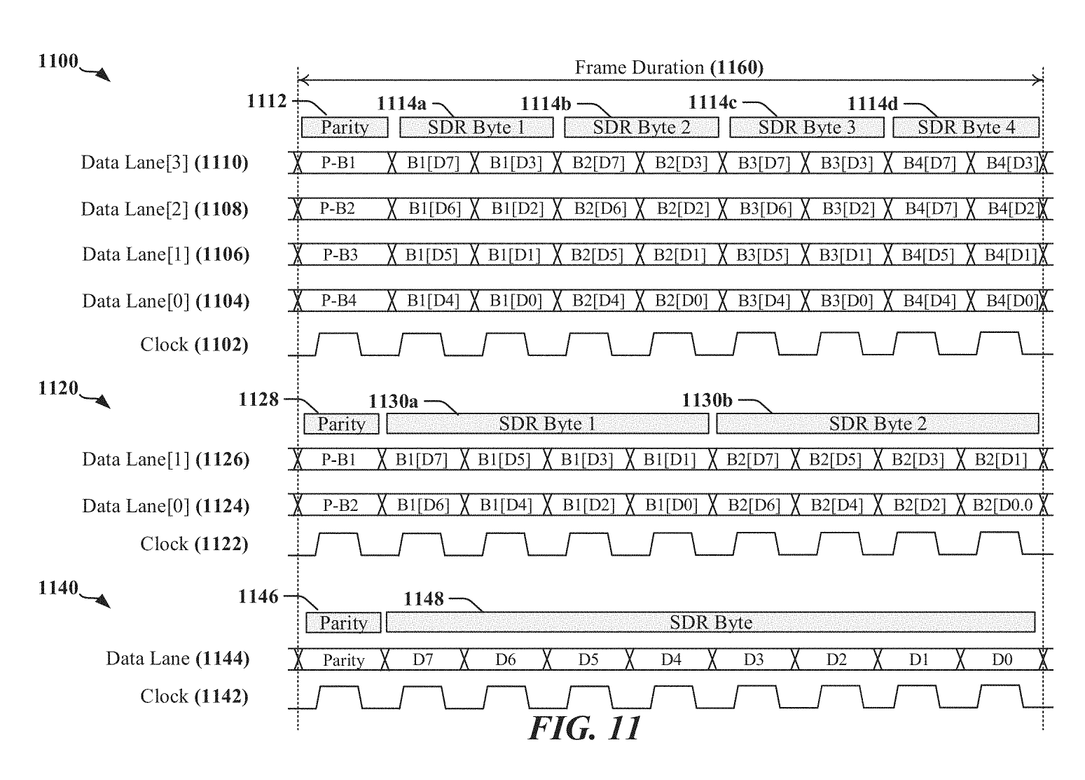

The location of parity transmission within a frame may be configured as desired or needed by application or hardware circuit design. FIG. 11 illustrates examples of datagram structures 1100, 1120, 1140 that may be transmitted during a device write where parity is transmitted with each byte of data. FIG. 11 illustrates data exchanges over an I3C serial bus operated in an SDR mode when two or more devices can be coupled to additional connectors, lines or wires. In each datagram structure 1100, 1120, 1140, a common transaction and/or frame duration 1160 is maintained regardless of the number of additional lines used. For example, a transaction that involves the use of 2 data lanes and one clock line can communicate twice as many bits as a transaction that uses 1 data lane and one clock signal.

In the examples illustrated in FIG. 11, a parity bit may be transmitted on each data lane concurrently and in accordance with a common clock pulse. Parity transmissions 1112, 1128, 1146 occurs before transmission of data bytes 1114a-1114d, 1130a-1130b, 1148. Allocation of parity bits to data lanes may be configured based on application needs and/or circuit design. In the multi-lane configurations of FIG. 11, a receiver possesses all of the parity bits associated with a frame when data bytes 1114a-1114d, 1130a-1130b are received and the receiver can validate the data bytes 1114a-1114d, 1130a-1130b as they are received. When parity bits are received after the data bytes 1114a-1114d, 1130a-1130b, additional storage may be required to hold the data bytes 1114a-1114d, 1130a-1130b until validation.

In the first datagram structure 1140, no additional lines are used and communication proceeds using two lines (clock line 1142 and one data lane 1144). A serialized data byte 1148 may be transmitted after a parity transmission 1112 where a parity bit is sent on the data lane 1144.

In a second datagram structure 1120, one additional line is used and communication proceeds using three lines (clock line 1122 and two data lanes 1124, 1126). Two data bytes 1130a, 1130b may be transmitted after a parity transmission 1128 where up to two parity bits are transmitted on the data lanes 1126, 1124. In the example, the data bytes 1130a, 1130b are transmitted in a striped mode, whereby a first data byte 1130a is completely transmitted in two-bit nibbles on the two data lanes before the second data byte 1130b is transmitted. In other implementations, data bytes may be transmitted in parallel on the two data lanes.

In a third datagram structure 1100, three additional lines are used and communication proceeds using five lines (clock line 1102 and four data lanes 1104, 1106, 1108, 1110). Four data bytes 1114a, 1114b, 1114c and 1114d may be transmitted after a parity transmission 1146 where up to four parity bits transmitted on the data lanes 1104, 1106, 1108, 1110. In the example, the data bytes 1114a, 1114b, 1114c, 1114d are transmitted in a striped mode, whereby a first data byte 1114a is completely transmitted in four-bit nibbles on the four data lanes before the second data byte 1114b is transmitted. In other implementations, data bytes may be transmitted in parallel on the four data lanes. In each of the datagram structures 1100, 1120, 1140 in FIG. 11, data is clocked on one edge of each clock pulse in the clock signal transmitted on the clock line 1102, 1122, 1142, in accordance with I3C SDR protocols.

In the examples illustrated in FIGS. 10 and 11, the maximum possible bytes are transmitted in multi-lane configurations. In some instances, fewer bytes may be transmitted. For example, the four-line datagram structure 1100 of FIG. 11 can carry up to four bytes of data. When an odd number of bytes are allocated to one or more datagrams having the datagram structure 1100, then at least one of the datagrams is transmitted with less than four bytes. In certain implementations, the full number of time slots allocated to an unfilled datagram are transmitted to maintain bus cadence.

Outside-Device Alert for a Shared Multi-Lane Serial Bus

According to certain aspects disclosed herein, outside devices may be defined as devices that are not participants in a transaction conducted over a serial bus may send an alert to request access to the serial bus. The alert may involve modifying and/or driving the data lane after transmission of a data byte. When a serial is operating using additional data lanes for a transaction between two devices, the alert mechanism can be configured to support multi-lane devices and devices that support or are coupled to a single data lane. In one example, the alert mechanism may operate in the manner of an in-band interrupt.

The ability for an outside device to launch a non-destructive alert in order to terminate a transaction may be limited when the transaction involves multi-lane devices that are transmitting multiple frames of data. A non-destructive alert may be an alert that is launched through signaling that does not corrupt or modify data transmitted in a frame. According to certain aspects disclosed herein, an abrupt datagram termination may be initiated by an outside device at the boundary of certain datagrams.

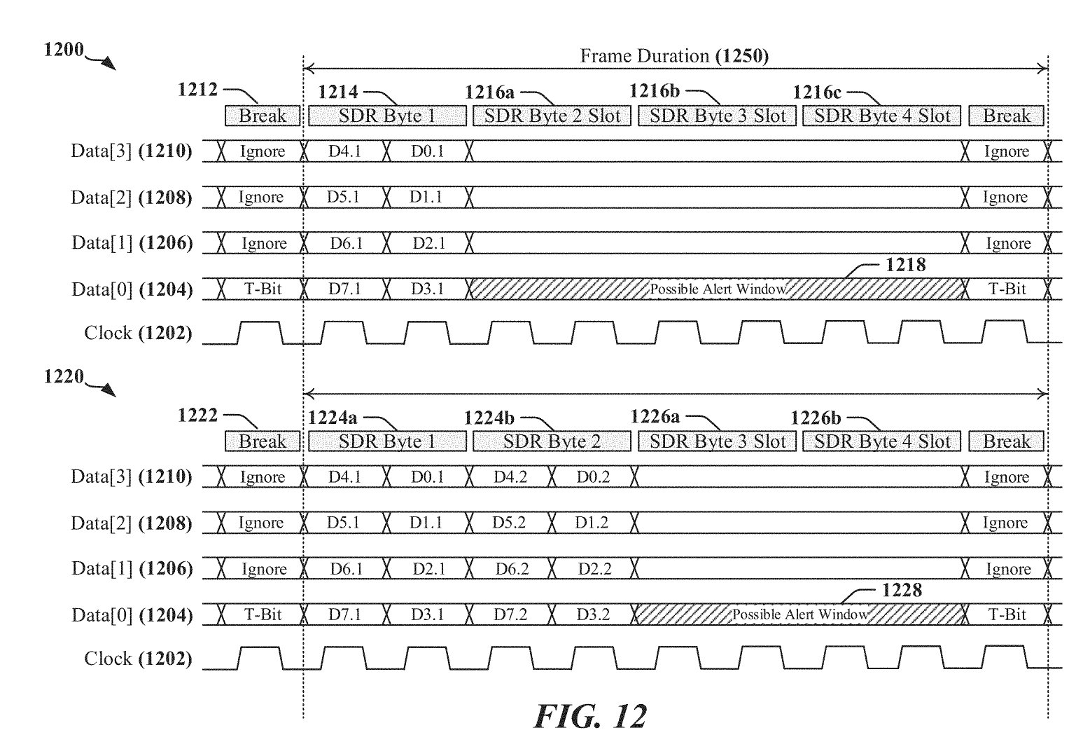

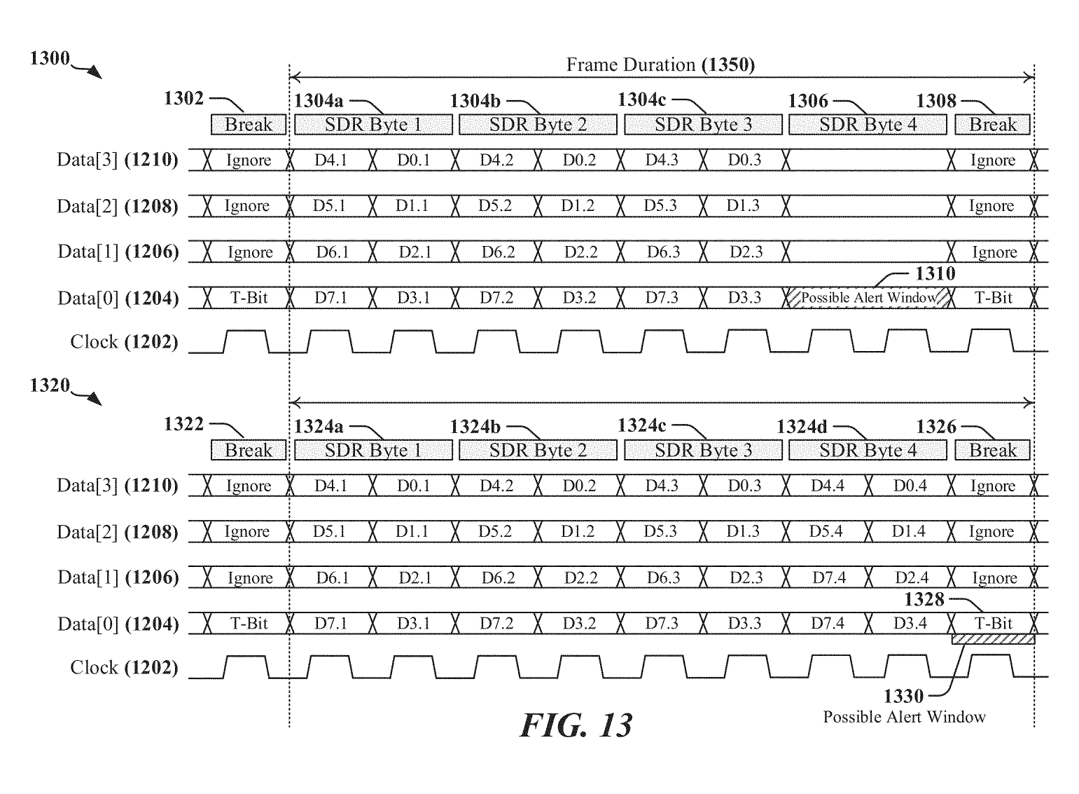

FIGS. 12 and 13 illustrate multi-lane read frames 1200, 1220, 1300, 1320 that provide alert opportunities (alert windows 1218, 1228, 1310, 1330). A first multi-lane read frame 1200 carries a single byte 1214, with three unused byte transmission slots 1216a, 1216b, 1216c. The unused byte transmission slots 1216a, 1216b, 1216c provide an alert window 1218 during which an outside device may launch a non-destructive alert. A second multi-lane read frame 1220 carries two bytes 1224a, 1224b with two unused byte transmission slots 1226a, 1226b. The unused byte transmission slots 1226a, 1226b provide an alert window 1228 during which an outside device may launch a non-destructive alert. A third multi-lane read frame 1300 carries three bytes 1304a, 1304b, 1304c, with one unused byte transmission slots 1306 (followed by the break bits or parity bits 1308). The unused byte transmission slot 1306 provides an alert window 1310 during which an outside device may launch a non-destructive alert. A fourth multi-lane read frame 1320 carries a full complement of four bytes 1324a, 1324b, 1324c, 1324d with no unused byte transmission slots before the break bit or bits 1326. According to certain I3C protocols, a transition bit (T-Bit 1328) provides an alert window 1330. An alert launched during transmission of the T-Bit 1328 is considered to be non-destructive to the transmitted bytes 1324a, 1324b, 1324c, 1324d. In one example, the alert window 1330 is available when an alert permission code (AC) has been set to 1. If the AC is not set, the outside device is not permitted to launch an alert during transmission of the T-Bit 1328.

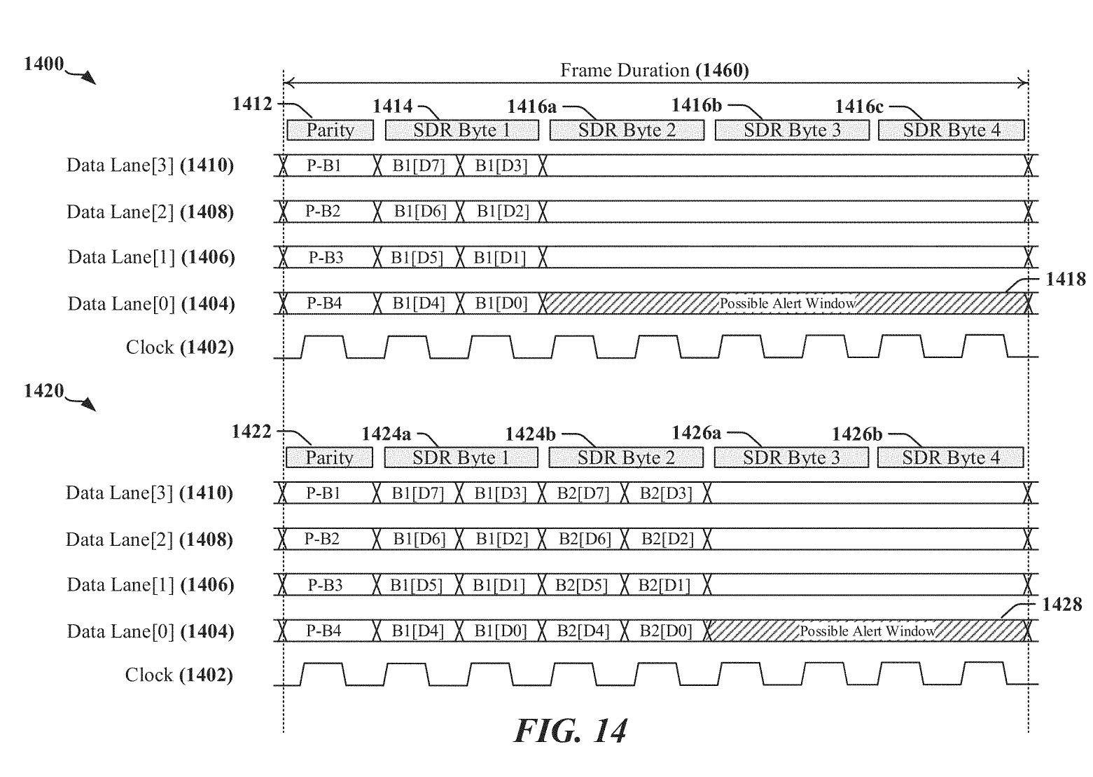

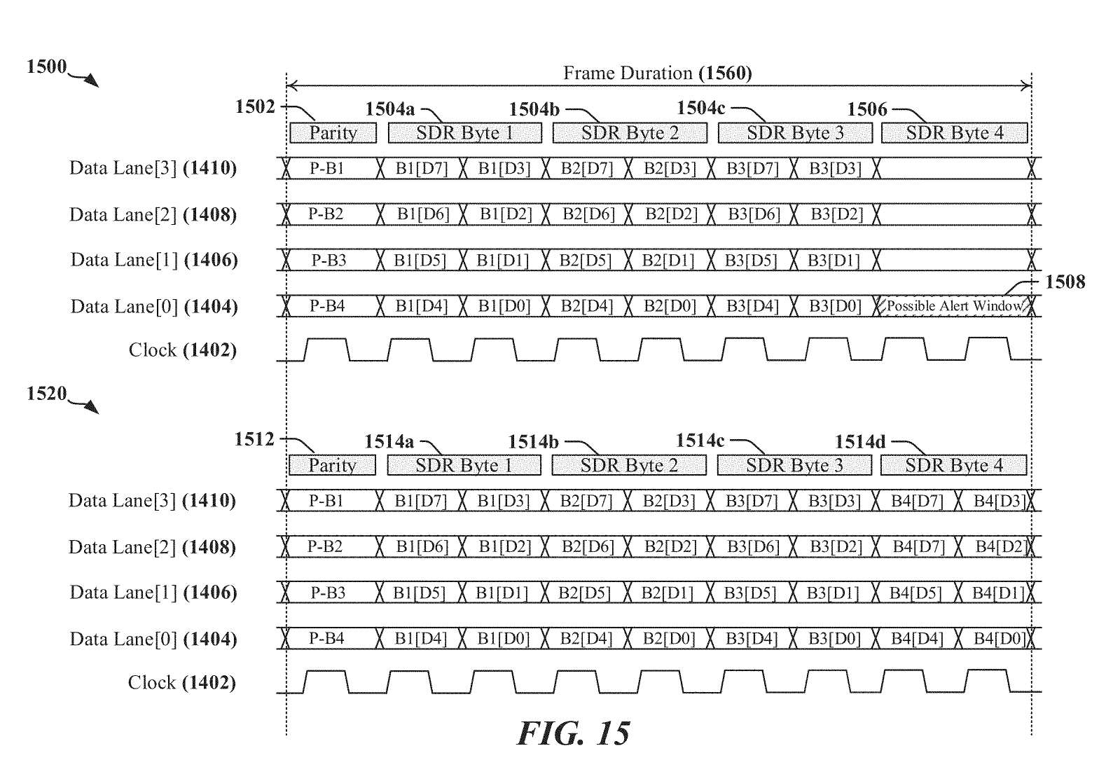

FIGS. 14 and 15 illustrate multi-lane write frames 1400, 1420, 1500 that provide alert opportunities or windows 1418, 1428, 1508, and a fully-occupied multi-lane write frame 1520 that does not offer an opportunity for an alert that is non-destructive to the transmitted bytes 1514a, 1514b, 1514c, 1514d. A first multi-lane write frame 1400 carries a single byte 1414, with three unused byte transmission slots 1416a, 1416b, 1416c. The unused byte transmission slots 1416a, 1416b, 1416c provide an alert window 1418 during which an outside device may launch a non-destructive alert. A second multi-lane write frame 1420 carries two bytes 1424a, 1424b with two unused byte transmission slots 1426a, 1426b. The unused byte transmission slots 1426a, 1426b provide an alert window 1428 during which an outside device may launch a non-destructive alert. A third multi-lane write frame 1500 carries three bytes 1504a, 1504b, 1504c, with one unused byte transmission slot 1506. The unused byte transmission slot 1506 provides an alert window 1508 during which an outside device may launch a non-destructive alert. The fourth multi-lane write frame 1520 carries a full complement of four bytes 1514a, 1514b, 1514c, 1514d with no unused byte transmission slots.

Certain aspects disclosed herein provide apparatus, techniques and procedures by which non-destructive alerts can be launched during prolonged data transfer transactions on a multi-lane serial bus. In conventional systems, alert opportunities may be unavailable for relatively long periods of time when a transaction involves many frames filled with data bytes, including the read frame 1320 and write frame 1520. In one example, two multi-lane common command codes (CCCs) may be defined for multi-lane transfer. The CCCs may be transmitted prior to a data transmission to ensure non-destructive alert launch by an outside device. A first multi-lane common command code (CCC-1) may precede a data transmission to indicate that an outside-device is unable to launch alerts during the ninth clock cycle of each frame. A second multi-lane common command code (CCC-2) may precede the data transmission to indicate that an outside-device can launch alerts during the ninth clock cycle of each frame.

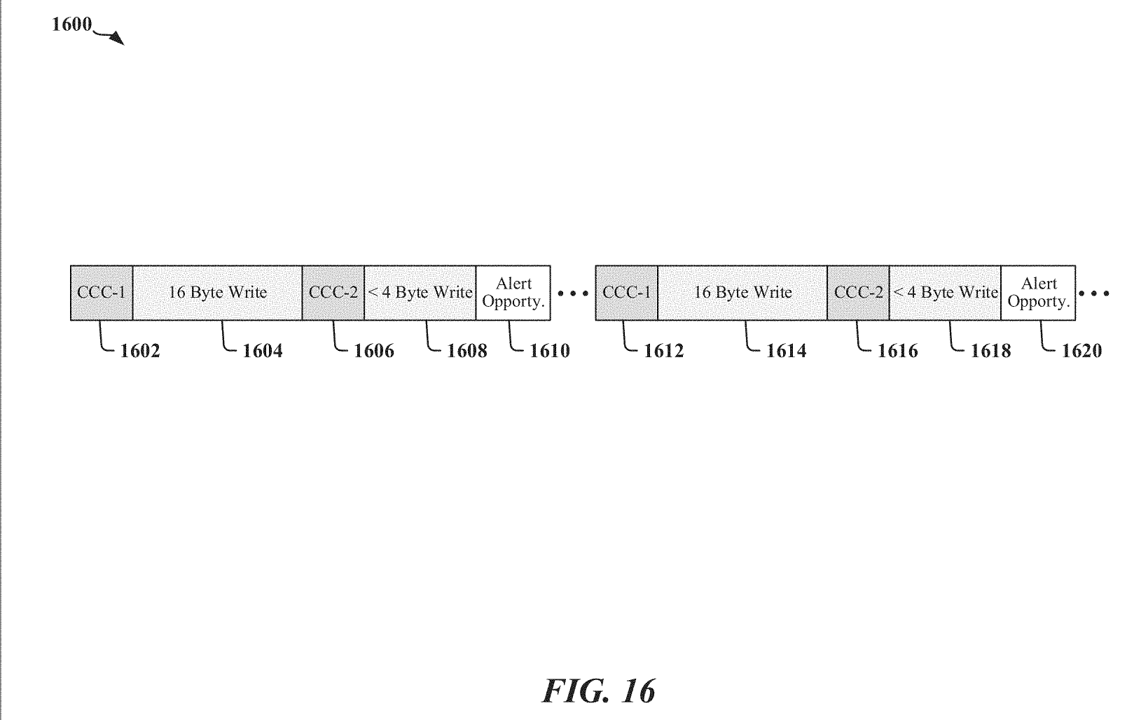

The series of datagrams 1600 in FIG. 16 provides an example of the operation of multi-lane CCCs 1602, 1606 in accordance with certain aspects disclosed herein. A first datagram 1604 carries 16 bytes and is preceded by a first CCC-1 1602. The first CCC-1 1602 indicates that an outside-device should not attempt to launch alerts while the first datagram 1604 is being transmitted. A second datagram 1608 is unfilled (e.g. less than four byes in a four data lane multi-lane interface), and is preceded by a first CCC-2 1606. The first CCC-2 1606 indicates that an outside-device can launch alerts while the second datagram 1608 is being transmitted. A third datagram 1614 carries 16 bytes and is preceded by a second CCC-1 1612. The second CCC-1 1612 indicates that an outside-device should not attempt to launch alerts while the third datagram 1614 is being transmitted. A fourth datagram 1618 is unfilled, and is preceded by a second CCC-2 1616. The second CCC-2 1616 indicates that an outside-device can launch alerts while the fourth datagram 1618 is being transmitted. The transmission can continue in this manner.

According to certain aspects disclosed herein, the multi-lane common command codes can be used to implement a programmable fair-opportunity policy to ensure that the transmitting device can provide varying degrees of fairness, which may be characterized by a number or frequency of alert opportunity windows. The degree of fairness may be determined by an application, a protocol or by configuration. In some instances, the rate at which alert opportunity windows are provided may be measured by the number of bytes or frames transmitted without alert opportunity windows. In one example, a transmission pattern may be defined by an “Alert Opportunity Register” setting.

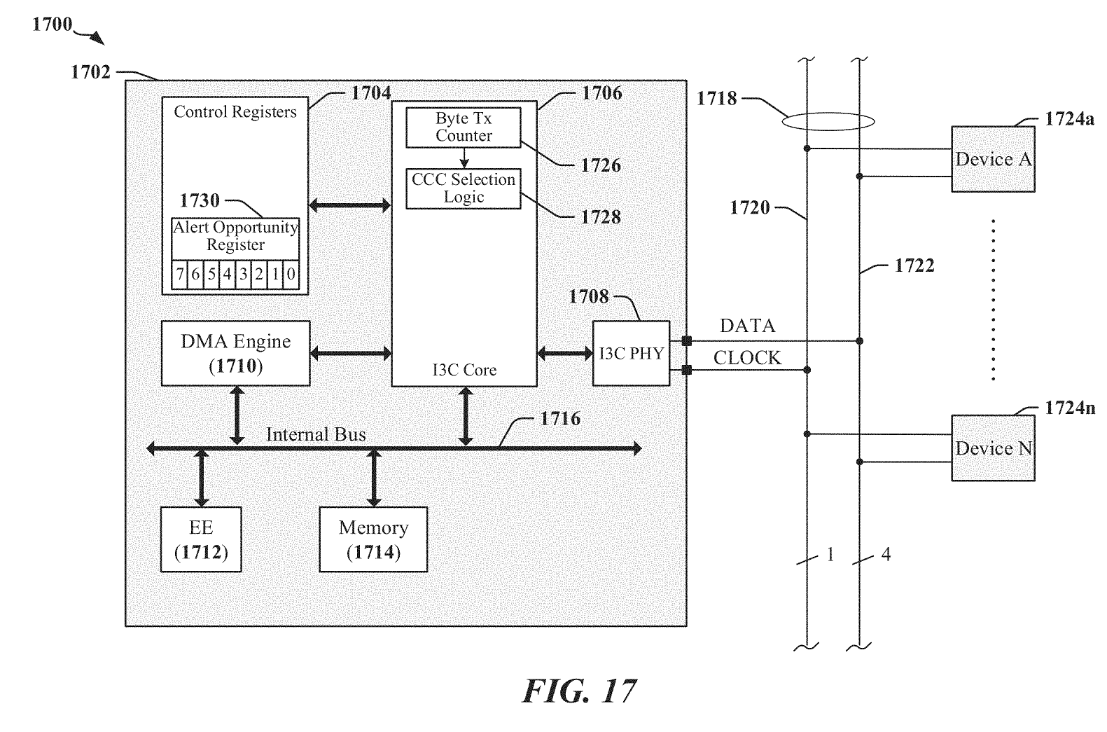

FIG. 17 illustrates a system 1700 that includes one or more devices 1702, 1724a-1724n that may be adapted in accordance with certain aspects disclosed herein. One device 1702 includes an I3C core 1706 coupled to a multi-wire serial bus 1718 that has one clock line 1720 and four data lanes 1722. The I3C core may maintain and/or be configured by control registers 1704, including an Alert Opportunity Register 1730. The I3C core 1706 may be coupled through an internal bus 1716 to other devices, including a direct memory access engine 1710, EEPROM 1712 and other storage or memory 1714.

The I3C core 1706 may include logic circuits that may be used to implement a fairness policy for alert launching. In one example, the I3C core 1706 includes a transmission byte counter 1726 configured to count the number of bytes transmitted over the multi-wire serial bus 1718, and to control CCC selection logic 1728 based on the number of bytes transmitted. In one example, the Alert Opportunity Register 1730 indicates a maximum number of bytes to be transmitted before an alert opportunity window is provided. The value of the Alert Opportunity Register 1730 may be initially loaded into the transmission byte counter 1726, which then decrements with each byte or frame transmitted. Transmission of frames are preceded by CCC-1 1602, 1612 until the transmission byte counter 1726 reaches zero. An unfilled frame may be transmitted next and preceded by a CCC-2 1606, 1616. The I3C core 1706 may break the payload into portions that enable alerts and portions in which alerts should not be launched.

When receiving, the I3C core 1706 may read the Alert Opportunity Register 1730 setting to know how many consecutive filled frames are to be received before a transmission alert opportunity becomes available. The I3C core 1706 may set its AC bit as needed, based on the Alert Opportunity Register 1730 value.

FIGS. 12-15 illustrate certain instances where data available at a transmitter is insufficient to fill byte transmission slots of a multilane serial bus operated in an SDR mode. Unused byte transmission slots may provide alert opportunities. Frames transmitted on a multilane serial bus operated in a DDR mode may have unused word transmission slots. The design of transmitter and receiver circuit can be simplified when SDR frames and/or DDR frames with are transmitted a constant number of slots, even when one or more slots are unused. These simplified circuits may be leveraged to provide the alert opportunities in unused transmission slots of frames, and to transmit the full number of time slots allocated to an unfilled datagram, thereby maintaining bus cadence.

In some implementations, the unused transmission slots may include filler bytes or words. The filler bytes or words may have all bits set to a common value (i.e., logic 0 or logic 1), or may be configured to produce a signaling pattern on one or more lanes. Information indicating the number of valid bytes or words may be provided to a receiver to enable filler bytes or words to be discarded. According to certain aspects disclosed herein, filler bytes or words may be explicitly indicated in transmitted frames.

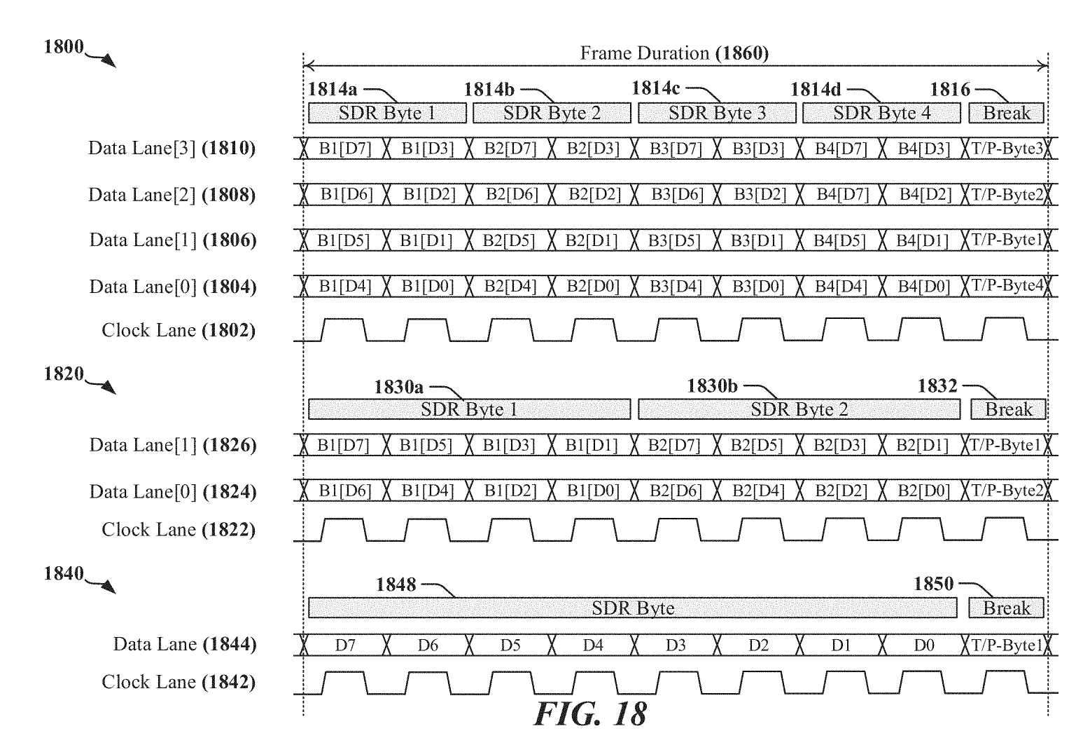

FIG. 18 illustrates generalized data exchanges over an I3C serial bus operated in an SDR mode when two or more devices can be coupled to additional connectors, lines or wires. In each datagram structure 1800, 1820, 1840 a common transaction and/or frame duration 1860 is maintained regardless of the number of additional lines used. For example, a transaction that involves the use of 2 data lanes and one clock line can communicate twice as many bits as a transaction that uses 1 data lane and one clock signal. Additional bits may be transmitted, including payload data bits, parity bits, control bits, command bits, other protocol-defined bits and/or other information. In some implementations, devices coupled to the bus and configured for a conventional two-line mode of operation remain unaware of the use of additional lines. In some instances, a parity bit or a T-bit may be transmitted concurrently on each data lane. In some implementations, a common transaction and/or frame duration 1860 can be provided using break point time-slots 1816, 1832, 1850 between frames. The common transaction and/or frame duration 1860 may define a cadence for bus operations.

In the first datagram structure 1840, no additional lines are used and communication proceeds using two lines (clock line 1842 and one data lane 1844). A time-slot 1850 that carries a T-bit or parity bit is transmitted on the data lane 1844. The T-bit and parity bit settings may operate as defined by conventional protocol since no filler byte is transmitted in the first datagram structure 1840.

In a second datagram structure 1820, one additional line is used and communication proceeds using three lines (clock line 1822 and two data lanes 1824, 1826). Valid data bytes may be identified in a time-slot 1832 that carries T-bits or parity bits for each byte striped across the data lanes 1824, 1826. A T-bit or parity bit is transmitted for each of the two data bytes 1830a, 1830b transmitted on one of the data lanes 1826, 1824. In the example, a first data byte 1830a is completely transmitted in two-bit nibbles on the two data lanes before the second data byte 1830b can be transmitted and T-bits or parity bits may be allocated to the data bytes 1830a, 1830b as defined by protocol or agreed between the receiver and transmitter. In the example, the T-bit or parity bit corresponding to the second-in-sequence data byte 1830b is transmitted on Data Lane[0] 1824. In other implementations, data bytes may be transmitted in parallel on the two data lanes.

In another datagram structure 1800, three additional lines are used and communication proceeds using five lines (clock line 1802 and four data lanes 1804, 1806, 1808, 1810). Valid data bytes may be identified in a time-slot (e.g., the break point time-slot 1816) that carries T-bits or parity bits for each byte striped across the data lanes 1804, 1806, 1808, 1810. A T-bit or parity bit is transmitted for each of four data bytes 1814a, 1814b, 1814c and 1814d. In the example, the data bytes 1814a, 1814b, 1814c, 1814d are transmitted in a striped mode, whereby a first data byte 1814a is completely transmitted in four-bit nibbles on the four data lanes before the second data byte 1814b is transmitted. In the example, the T-bit or parity bit corresponding to the fourth-in-sequence data byte 1814d is transmitted on Data Lane[0] 1804. In other implementations, data bytes may be transmitted in parallel on the four data lanes. In each of the datagram structures 1800, 1820, 1840 in FIG. 18, data is clocked on one edge of each clock pulse in the clock signal transmitted on the clock line 1802, 1822, 1842, in accordance with I3C SDR protocols.

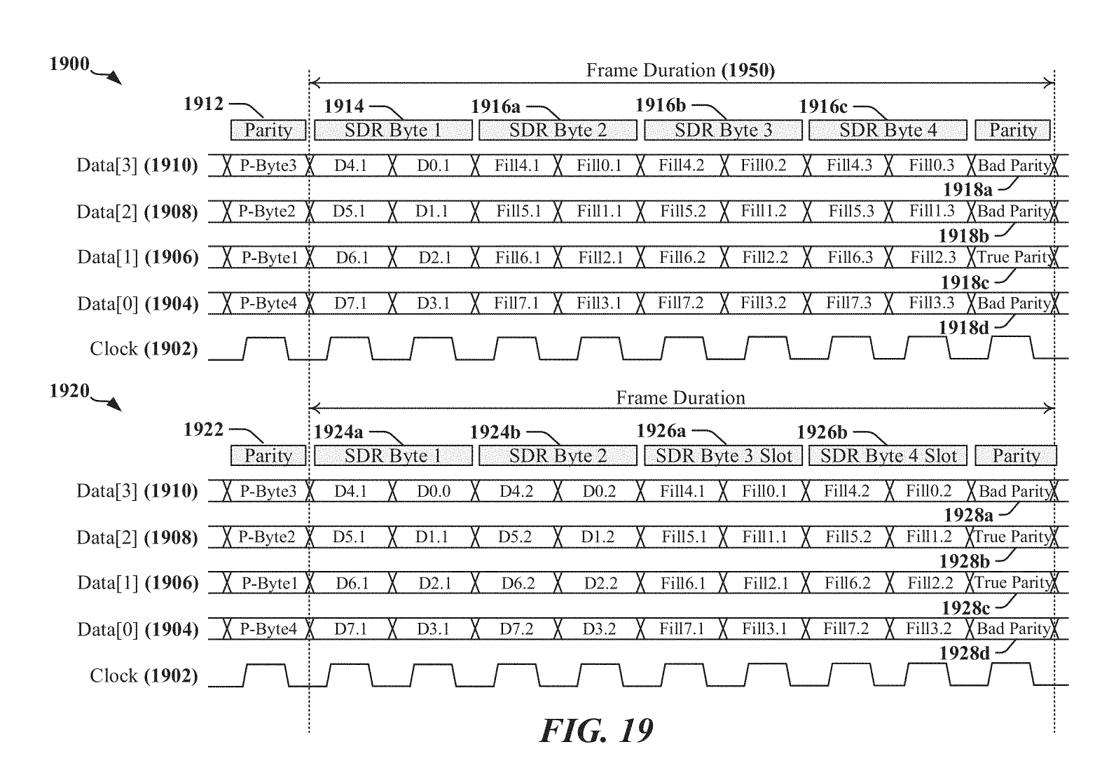

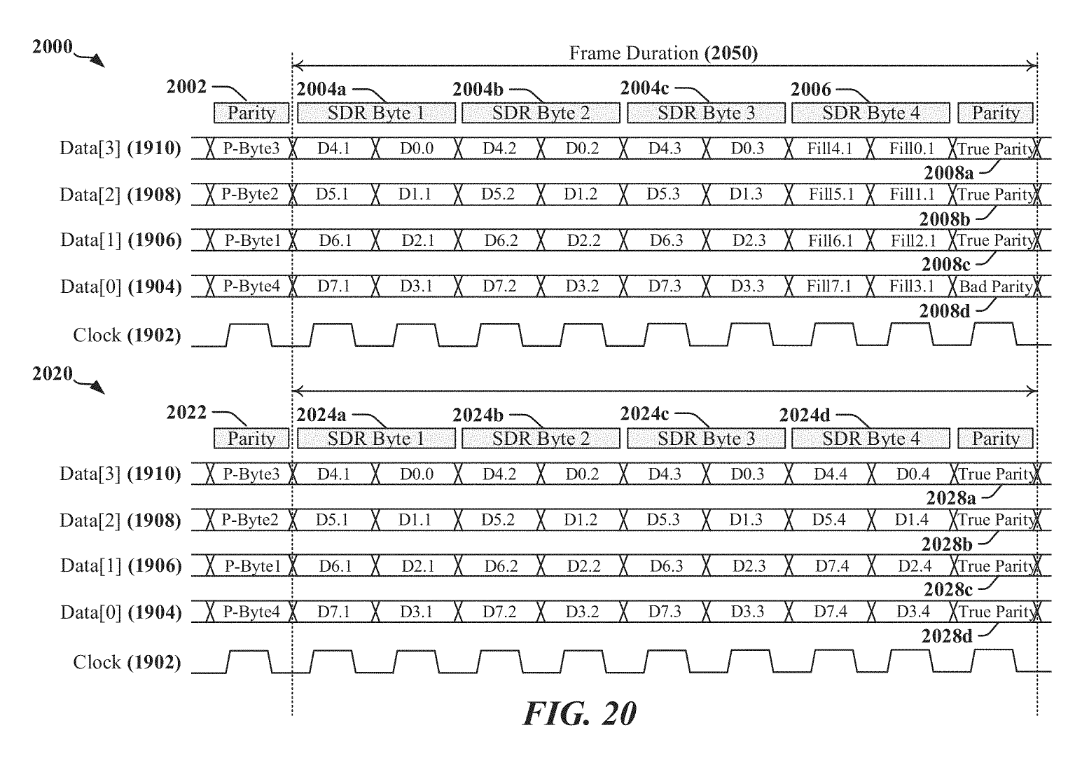

FIGS. 19 and 20 illustrate multi-lane write frames 1900, 1920, 2000 that include filler bytes 1916a, 1916b, 1916c, 1926a, 1926b, 2006, and a fully-occupied multi-lane write frame 2020. A first multi-lane write frame 1900 carries a single data byte 1914, with three filler bytes 1916a, 1916b, 1916c. Each filler byte 1916a, 1916b, 1916c is transmitted with a corresponding parity bit 1918a, 1918b, 1918c that causes a parity detector in a receiver to detect bad parity associated with received filler bytes 1916a, 1916b, 1916c. The receiver may discard each filler byte 1916a, 1916b, 1916c based on detection of bad parity. A first detection of bad parity in a frame may cause the receiver to discard all remaining bytes in the frame. A second multi-lane write frame 1920 carries two data bytes 1924a, 1924b with two filler bytes 1926a, 1926b. Each filler byte 1926a, 1926b is transmitted with a corresponding parity bit 1928a, 1928b that causes a parity detector in a receiver to detect bad parity associated with received filler bytes 1926a, 1926b. The receiver may discard each filler byte 1926a, 1926b based on detection of bad parity. Detection of bad parity of the first filler byte 1926a in a frame may cause the receiver to discard the second filler byte 1926b. A third multi-lane write frame 2000 carries three data bytes 2004a, 2004b, 2004c, with one filler byte 2006. The filler byte 2006 is transmitted with a parity bit 2008d that causes a parity detector in a receiver to detect bad parity associated with received filler byte 2006. The receiver may discard the filler byte 2006 based on detection of bad parity. The fourth multi-lane write frame 2020 carries a full complement of four data bytes 2024a, 2024b, 2024c, 2024d with no unused byte transmission slots. The parity bits 1918c, 1928b, 1928c, 2008a, 2008b, 2008c, 2028a, 2028b, 2028c, 2028d associated with valid data bytes 1914, 1924a, 1924b, 2004a, 2004b, 2004c, 2024a, 2024b, 2024c, 2024d may carry calculated (true) parity bit values.

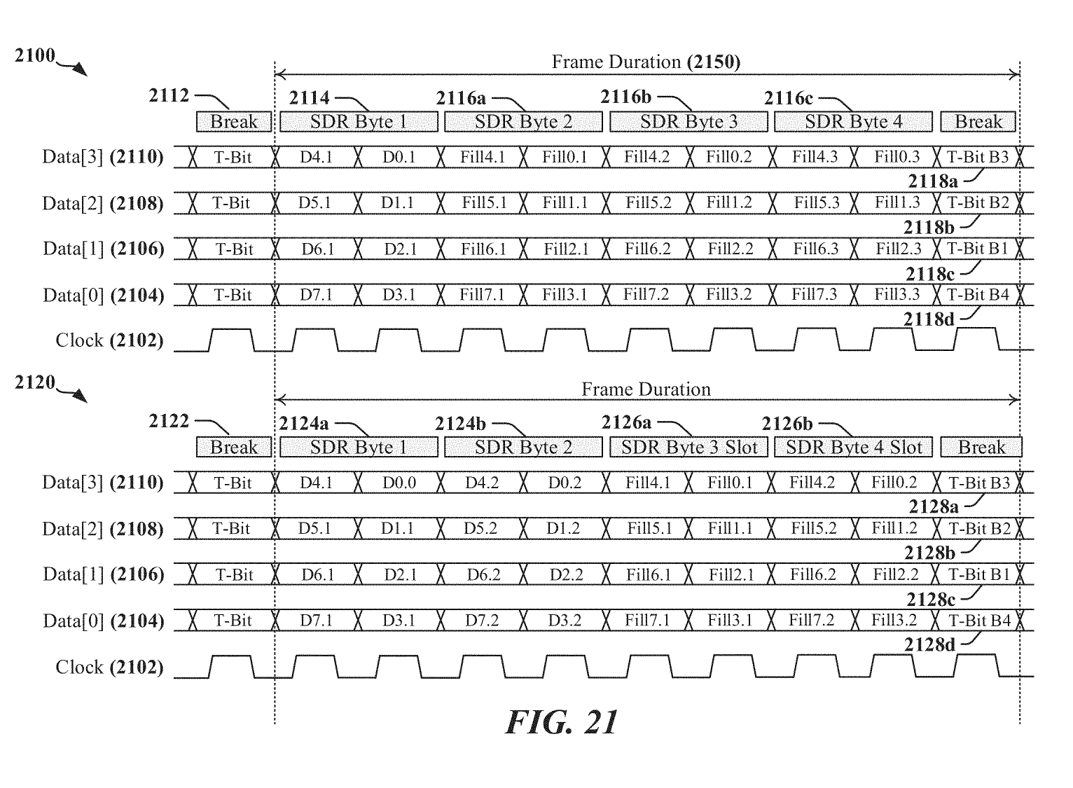

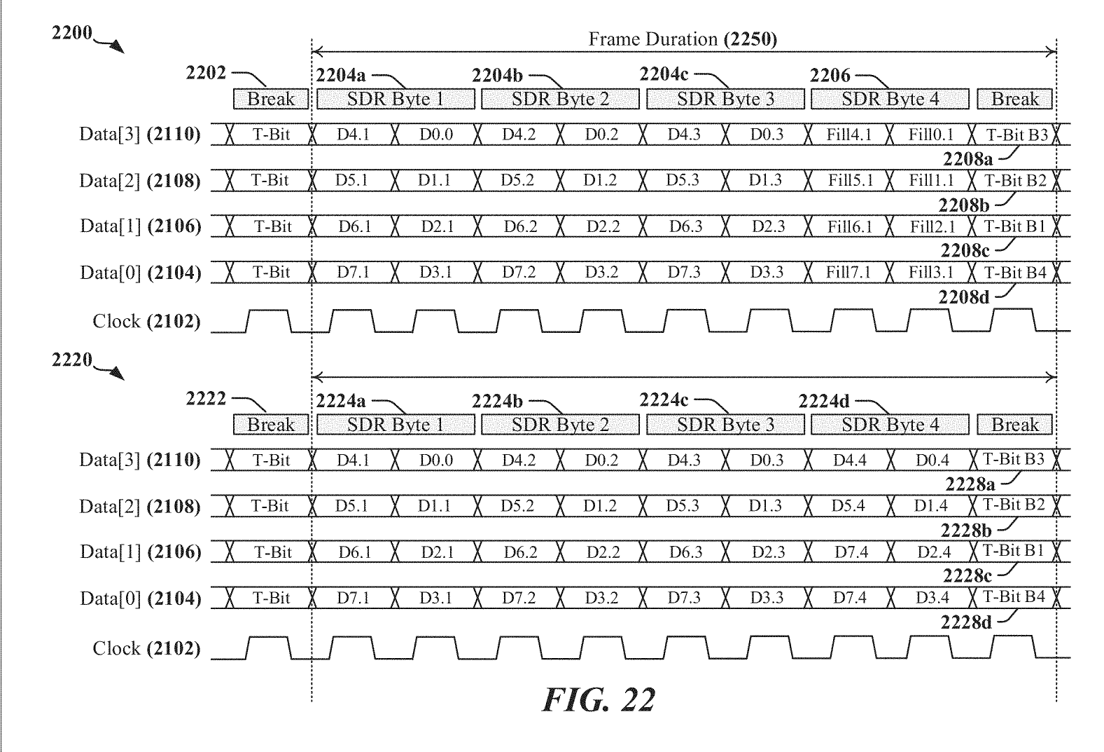

FIGS. 21 and 22 illustrate multi-lane read frames 2100, 2120, 2200 that include filler bytes 2116a, 2116b, 2116c, 2126a, 2126b, 2206, and a fully-occupied multi-lane write frame 2220. A first multi-lane write frame 2100 carries a single data byte 2114, with three filler bytes 2116a, 2116b, 2116c. Each filler byte 2116a, 2116b, 2116c may be identified by a corresponding T-Bit 2118a, 2118b, 2118c. The receiver may discard each filler byte 2116a, 2116b, 2116c based on setting of the corresponding T-Bit 2118a, 2118b, 2118c. A second multi-lane write frame 2120 carries two data bytes 2124a, 2124b with two filler bytes 2126a, 2126b. Each filler byte 2126a, 2126b may be identified by a corresponding T-Bit 2128a, 2128b. The receiver may discard each filler byte 2126a, 2126b based on setting of the corresponding T-Bit 2128a, 2128b. A third multi-lane write frame 2200 carries three data bytes 2204a, 2204b, 2204c, with one filler byte 2206. The filler byte 2206 may be identified by a corresponding T-Bit 2208d. The receiver may discard the filler byte 2206 based on setting of the T-Bit 2208d. The fourth multi-lane write frame 2220 carries a full complement of four data bytes 2224a, 2224b, 2224c, 2224d with no unused byte transmission slots. The T-bits 2118c, 2128b, 2128c, 2208a, 2208b, 2208c, 2228a, 2228b, 2228c, 2228d associated with valid data bytes 2114, 2124a, 2124b, 2204a, 2204b, 2204c, 2224a, 2224b, 2224c, 2224d may operate as defined by a conventional or adapted protocol.

Certain concepts disclosed with respect to FIGS. 18-22 with respect to I3C SDR mode communication are applicable to I3C HDR-DDR mode. While certain frame configurations, location, size and/or type of control and data fields may differ between communication modes (e.g., I3C SDR and I3C HDR-DDR modes), techniques for identifying unused byte or word slots may be adapted for the type of communication mode. For example, the examples of FIGS. 18-22 illustrate examples in which data is striped across multiple lanes. When data is not striped, certain aspects and/or techniques disclosed herein may be adapted according to application needs.

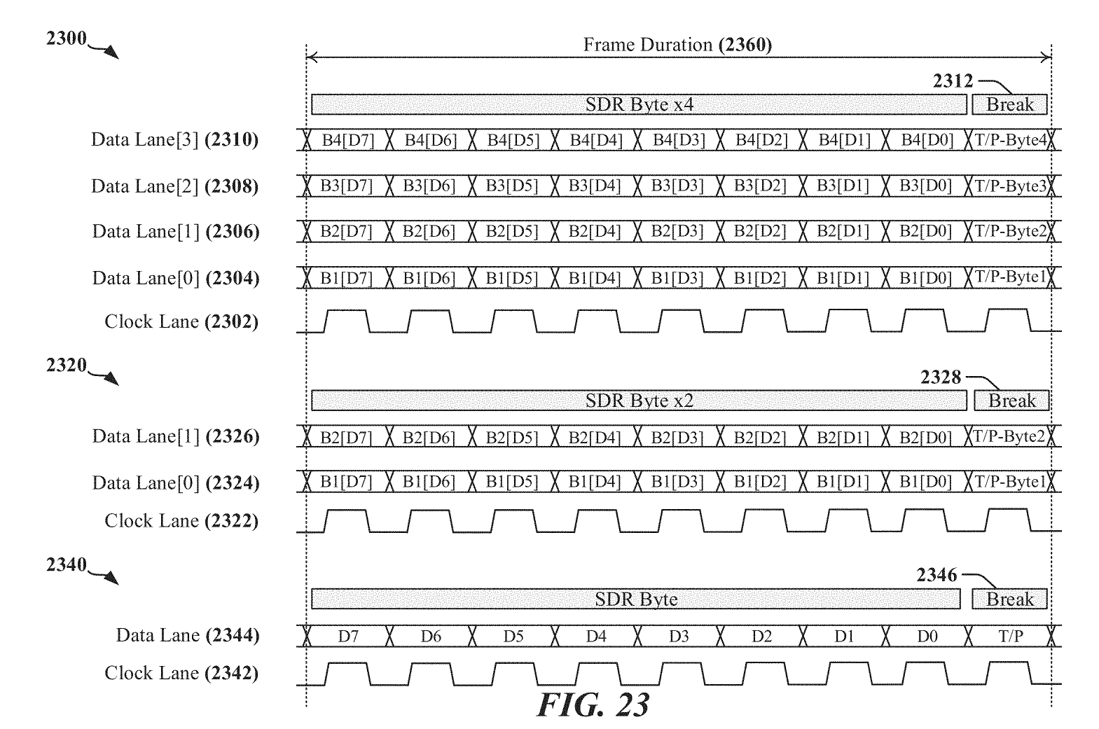

FIG. 23 illustrates generalized data exchanges over an I3C serial bus operated in an SDR mode when two or more devices can be coupled to additional connectors, lines or wires, and where each data byte or word is serialized and transmitted over a single lane. In each datagram structure 2300, 2320, 2340 illustrated in FIG. 23, a common transaction and/or frame duration 2360 is maintained and data bytes can be transmitted in parallel over multiple lanes 2304, 2306, 2308, 2310, 2324, 2326. Additional bits may be transmitted, including payload data bits, parity bits, control bits, command bits, other protocol-defined bits and/or other information. In some implementations, devices coupled to the bus and configured for a conventional two-line mode of operation remain unaware of the use of additional lines. In some instances, a parity bit or a T-bit may be transmitted concurrently on each data lane. In some implementations, a common transaction and/or frame duration 2360 can be provided using break point time-slots 2312, 2328, 2346 between frames. The common transaction and/or frame duration 2360 may define a cadence for bus operations.

In the first datagram structure 2340, no additional lines are used and communication proceeds using two lines (clock line 2342 and one data lane 2344). A break point time-slot 2346 that carries a T-bit or parity bit is transmitted on the data lane 2344. The T-bit and parity bit settings may operate as defined by conventional protocol since no filler byte is transmitted in the first datagram structure 2340.

In a second datagram structure 2320, one additional line is used and communication proceeds using three lines (clock line 2322 and two data lanes 2324, 2326). Valid data bytes transmitted on data lanes 2324, 2326 may be identified by values of T-bit or based on a parity bit carried on the corresponding data lanes 2324, 2326 in the defined break point time-slot 2328. In the example, the T-bit or parity bit corresponding to the byte transmitted on Data Lane[0] 2324 is also transmitted on Data Lane[0] 2324.

In another datagram structure 2300, three additional lines are used and communication proceeds using five lines (clock line 2302 and four data lanes 2304, 2306, 2308, 2310). Valid data bytes may be identified in a time-slot 2312 that carries T-bits or parity bits, where data bytes are validated for each data lane 2304, 2306, 2308, 2310 based on the T-bits or parity bits carried on the data lane 2304, 2306, 2308, 2310. A T-bit or parity bit is transmitted for each of four data bytes.

In each of the datagram structures 2300, 2320, 2340 in FIG. 23, data is clocked on one edge of each clock pulse in the clock signal transmitted on the clock line 2302, 2322, 2342, in accordance with I3C SDR protocols. The configuration of data bytes transmissions on the serial bus, and relationship between data bytes and T-bits or parity bits may be selected in accordance with application needs and may vary from implementation to implementation. In some instances, other control fields may be used to signal validity of data in a frame. In some instances, other modes of communication may be supported such that the validity of data in a frame may be indicated to the receiver using parity, T-bits and control fields available to the other modes of communication.

### Examples of Processing Circuits and Methods

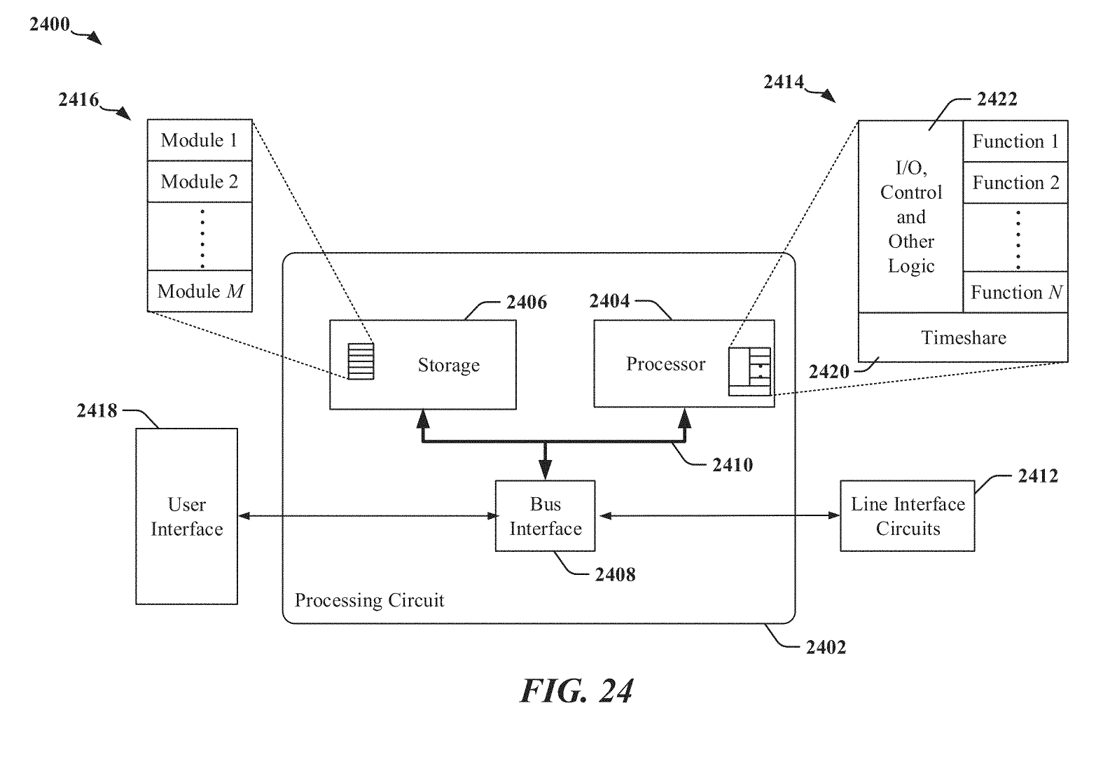

FIG. 24 is a diagram illustrating an example of a hardware implementation for an apparatus 2400 employing a processing circuit 2402 that may be configured to perform one or more functions disclosed herein. In accordance with various aspects of the disclosure, an element, or any portion of an element, or any combination of elements as disclosed herein may be implemented using the processing circuit 2402. The processing circuit 2402 may include one or more processors 2404 that are controlled by some combination of hardware and software modules. Examples of processors 2404 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 2404 may include specialized processors that perform specific functions, and that may be configured, augmented or controlled by one of the software modules 2416. The one or more processors 2404 may be configured through a combination of software modules 2416 loaded during initialization, and further configured by loading or unloading one or more software modules 2416 during operation. In various examples, the processing circuit 2402 may be implemented using a state machine, sequencer, signal processor and/or general-purpose processor, or a combination of such devices and circuits.

In the illustrated example, the processing circuit 2402 may be implemented with a bus architecture, represented generally by the bus 2410. The bus 2410 may include any number of interconnecting buses and bridges depending on the specific application of the processing circuit 2402 and the overall design constraints. The bus 2410 links together various circuits including the one or more processors 2404, and storage 2406. Storage 2406 may include memory devices and mass storage devices, and may be referred to herein as computer-readable media and/or processor-readable media. The bus 2410 may also link various other circuits such as timing sources, timers, peripherals, voltage regulators, and power management circuits. A bus interface 2408 may provide an interface between the bus 2410 and one or more transceivers 2412. A transceiver 2412 may be provided for each networking technology supported by the processing circuit. In some instances, multiple networking technologies may share some or all of the circuitry or processing modules found in a transceiver 2412. Each transceiver 2412 provides a means for communicating with various other apparatus over a transmission medium. Depending upon the nature of the apparatus 2400, a user interface 2418 (e.g., keypad, display, speaker, microphone, joystick) may also be provided, and may be communicatively coupled to the bus 2410 directly or through the bus interface 2408.

A processor 2404 may be responsible for managing the bus 2410 and for general processing that may include the execution of software stored in a computer-readable medium that may include the storage 2406. In this respect, the processing circuit 2402, including the processor 2404, may be used to implement any of the methods, functions and techniques disclosed herein. The storage 2406 may be used for storing data that is manipulated by the processor 2404 when executing software, and the software may be configured to implement any one of the methods disclosed herein.

One or more processors 2404 in the processing circuit 2402 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 2406 or in an external computer-readable medium. The external computer-readable medium and/or storage 2406 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 2406 may also include, by way of example, a carrier wave, a transmission line, and any other suitable medium for transmitting software and/or instructions that may be accessed and read by a computer. Computer-readable medium and/or the storage 2406 may reside in the processing circuit 2402, in the processor 2404, external to the processing circuit 2402, or be distributed across multiple entities including the processing circuit 2402. The computer-readable medium and/or storage 2406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 2406 may maintain software maintained and/or organized in loadable code segments, modules, applications, programs, etc., which may be referred to herein as software modules 2416. Each of the software modules 2416 may include instructions and data that, when installed or loaded on the processing circuit 2402 and executed by the one or more processors 2404, contribute to a run-time image 2414 that controls the operation of the one or more processors 2404. When executed, certain instructions may cause the processing circuit 2402 to perform functions in accordance with certain methods, algorithms and processes described herein.

Some of the software modules 2416 may be loaded during initialization of the processing circuit 2402, and these software modules 2416 may configure the processing circuit 2402 to enable performance of the various functions disclosed herein. For example, some software modules 2416 may configure internal devices and/or logic circuits 2422 of the processor 2404, and may manage access to external devices such as the transceiver 2412, the bus interface 2408, the user interface 2418, timers, mathematical coprocessors, and so on. The software modules 2416 may include a control program and/or an operating system that interacts with interrupt handlers and device drivers, and that controls access to various resources provided by the processing circuit 2402. The resources may include memory, processing time, access to the transceiver 2412, the user interface 2418, and so on.

One or more processors 2404 of the processing circuit 2402 may be multifunctional, whereby some of the software modules 2416 are loaded and configured to perform different functions or different instances of the same function. The one or more processors 2404 may additionally be adapted to manage background tasks initiated in response to inputs from the user interface 2418, the transceiver 2412, and device drivers, for example. To support the performance of multiple functions, the one or more processors 2404 may be configured to provide a multitasking environment, whereby each of a plurality of functions is implemented as a set of tasks serviced by the one or more processors 2404 as needed or desired. In one example, the multitasking environment may be implemented using a timesharing program 2420 that passes control of a processor 2404 between different tasks, whereby each task returns control of the one or more processors 2404 to the timesharing program 2420 upon completion of any outstanding operations and/or in response to an input such as an interrupt. When a task has control of the one or more processors 2404, the processing circuit is effectively specialized for the purposes addressed by the function associated with the controlling task. The timesharing program 2420 may include an operating system, a main loop that transfers control on a round-robin basis, a function that allocates control of the one or more processors 2404 in accordance with a prioritization of the functions, and/or an interrupt driven main loop that responds to external events by providing control of the one or more processors 2404 to a handling function.

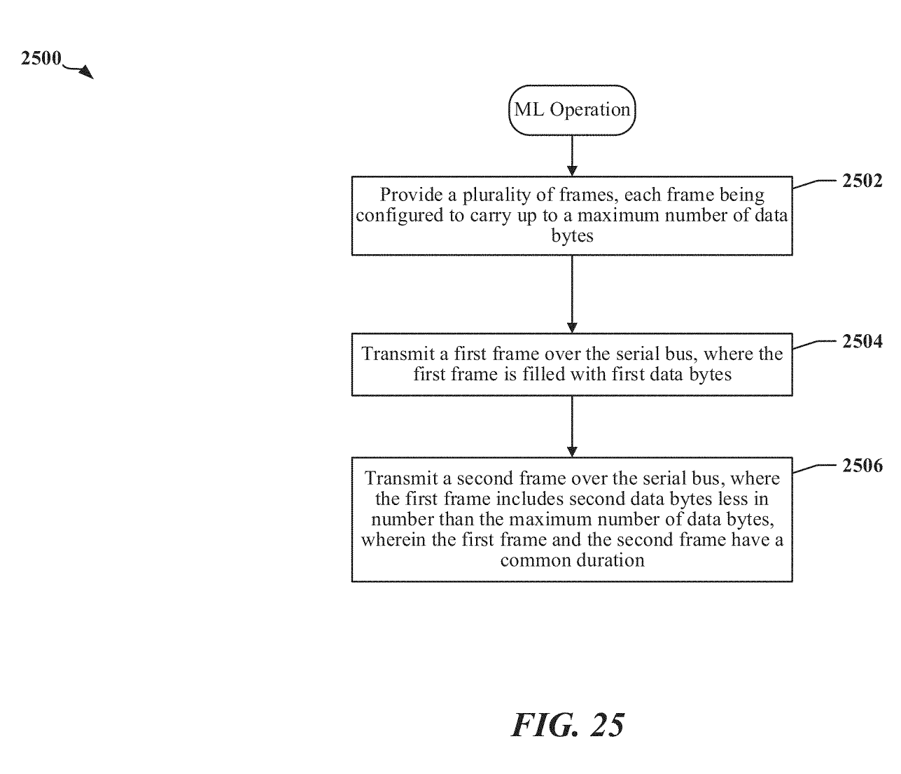

FIG. 25 is a flowchart 2500 illustrating a process that may be performed at a device coupled to a serial bus having multiple data lanes. In one example, the serial bus includes at 4 data lanes. In another example, the serial bus includes more than 4 data lanes. In another example, the serial bus includes less than 4 data lanes. At block 2502, the device may provide a plurality of frames, each frame being configured to carry up to a maximum number of data bytes. Each frame may be configured to stripe each byte across at least 4 data lanes. At block 2504, the device may transmit a first frame over the serial bus, where the first frame is filled with first data bytes. At block 2506, the device may transmit a second frame over the serial bus, where the first frame includes second data bytes less in number than the maximum number of data bytes and the first frame and the second frame have a common duration. Each of the plurality of frames includes parity bits or transition bits in each lane that indicate a number of data bytes transmitted in the frame.

In certain examples, the device may notify one or more devices of unavailability of an alert opportunity prior to transmitting the first frame and notify the one or more devices that the second frame provides an opportunity to launch an alert after transmission of the second data bytes. Notifying the one or more devices of unavailability of the alert opportunity may include transmitting a first command code over the serial bus prior to transmitting the first frame. Notifying the one or more devices that the second frame provides an opportunity to launch an alert may include transmitting a second command code over the serial bus prior to transmitting the first frame, the second command code being different from the first command code. Transmitting the second command code may include determining a total number of bytes transmitted after the first command code has been transmitted. The second command code may be transmitted when the total number of bytes transmitted.

In one example, the opportunity to launch the alert after transmission of the second data bytes is provided when no bit is transmitted on a data lane used by a device that is configured for communicating over a 2-line serial bus. In various examples, an alert launched by one of the one or more devices may be detected after transmission of the second data bytes and the device may terminate transmission over the serial bus in response to the alert.

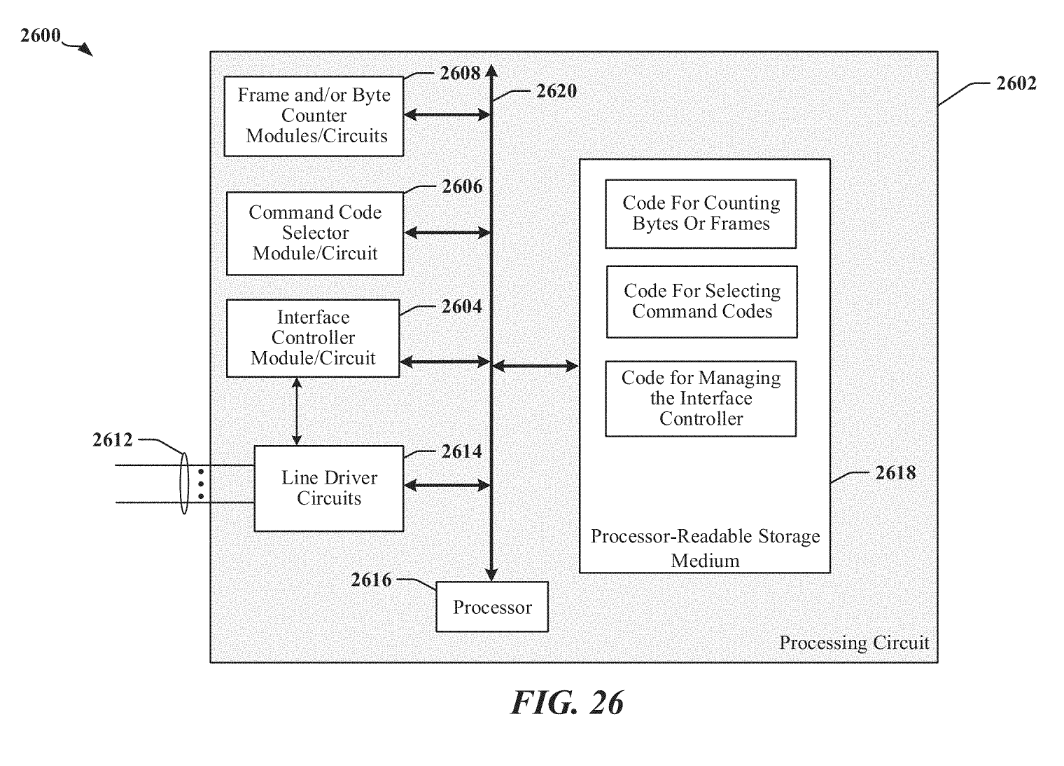

FIG. 26 is a diagram illustrating a simplified example of a hardware implementation for an apparatus 2600 employing a processing circuit 2602. The processing circuit typically has a controller or processor 2616 that may include one or more microprocessors, microcontrollers, digital signal processors, sequencers and/or state machines. The processing circuit 2602 may be implemented with a bus architecture, represented generally by the bus 2620. The bus 2620 may include any number of interconnecting buses and bridges depending on the specific application of the processing circuit 2602 and the overall design constraints. The bus 2620 links together various circuits including one or more processors and/or hardware modules, represented by the controller or processor 2616, the modules or circuits 2604, 2606 and 2608, and the processor-readable storage medium 2618. The apparatus may be coupled to a multi-wire communication link using a physical layer circuit 2614. The physical layer circuit 2614 may operate the multi-wire serial bus 2612 to support communications in accordance with I3C protocols. The bus 2620 may also link various other circuits such as timing sources, peripherals, voltage regulators, and power management circuits, which are well known in the art, and therefore, will not be described any further.

The processor 2616 is responsible for general processing, including the execution of software, code and/or instructions stored on the processor-readable storage medium 2618. The computer-readable storage medium may include a non-transitory storage medium. The software, when executed by the processor 2616, causes the processing circuit 2602 to perform the various functions described supra for any particular apparatus. The processor-readable storage medium 2618 may be used for storing data that is manipulated by the processor 2616 when executing software. The processing circuit 2602 further includes at least one of the modules 2604, 2606 and 2608. The modules 2604, 2606 and 2608 may be software modules running in the processor 2616, resident/stored in the processor-readable storage medium 2618, one or more hardware modules coupled to the processor 2616, or some combination thereof. The modules 2604, 2606 and 2608 may include microcontroller instructions, state machine configuration parameters, or some combination thereof.

In one configuration, the apparatus 2600 includes an interface controller, line driver and/or physical layer circuits 2614 including a first line driver coupled to a first wire of a multi-wire serial bus and a second line driver coupled to a second wire of the multi-wire serial bus 2612. The apparatus 2600 may include modules and/or circuits 2604, 2614 configured to transmit first data over the serial bus. The apparatus 2600 may include modules and/or circuits 2608 configured to count bytes or frames transmitted between alert opportunities. The apparatus 2600 may include modules and/or circuits 2606 configured to select command codes for transmission in order to manage alert opportunities.

The apparatus 2600 may include a bus interface configured to couple the apparatus 2600 to a multi-wire serial bus 2612, a first control register configured with a fairness value, and I3C logic having a byte counter. The I3C logic may be configured to cause the bus interface to transmit a first command code over the multi-wire serial bus 2612, transmit a plurality of frames over the multi-wire serial bus 2612, and transmit a second command code over the multi-wire serial bus 2612 after the byte counter indicates that a number of bytes transmitted since transmission of the first command code is at least equal to the fairness value. first command code may be configured to restrain one or more devices from launching an alert over the multi-wire serial bus 2612. The second command code may be configured to notify the one or more devices of an opportunity to launch an alert. The I3C logic may be configured to cause the bus interface to transmit at least one unfilled frame over the multi-lane serial bus after transmitting the second command code.

The processor-readable storage medium 2618 may store instructions for providing a plurality of frames, each frame being configured to carry up to a maximum number of data bytes, transmitting a first frame over the serial bus, where the first frame is filled with first data bytes, and transmitting a second frame over the serial bus, where the first frame includes second data bytes less in number than the maximum number of data bytes. The first frame and the second frame may have a common duration. Each of the plurality of frames may include parity bits or transition bits in each lane that indicate a number of data bytes transmitted in the frame.

The processor-readable storage medium 2618 may store further instructions for notifying one or more devices of unavailability of an alert opportunity prior to transmitting the first frame, and notifying the one or more devices that the second frame provides an opportunity to launch an alert after transmission of the second data bytes. The processor-readable storage medium 2618 may store further instructions for transmitting a first command code over the serial bus prior to transmitting the first frame. The processor-readable storage medium 2618 may store further instructions for transmitting a second command code over the serial bus prior to transmitting the first frame, the second command code being different from the first command code. The processor-readable storage medium 2618 may store further instructions for determining a total number of bytes transmitted after the first command code has been transmitted, and transmitting the second command code when the total number of bytes transmitted after the first command code is at least equal to a configured maximum number of bytes between alert opportunities. The opportunity to launch the alert after transmission of the second data bytes may be provided when no bit is transmitted on a data lane used by a device that is configured for communicating over a 2-line serial bus. The processor-readable storage medium 2618 may store further instructions for detecting an alert launched by the one of the one or more devices after transmission of the second data bytes, and terminating transmission over the serial bus in response to the alert.

The serial bus includes at least 2 data lanes. Each frame may be configured to stripe each byte across at least 2 data lanes.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for transmitting data over a serial bus having multiple data lanes, the method comprising:
providing a plurality of frames, each frame being configured to carry up to a maximum number of data bytes;
transmitting a first frame over the serial bus, wherein the first frame is filled with first data bytes; and
transmitting a second frame over the serial bus, wherein the second frame includes second data bytes less in number than the maximum number of data bytes, and wherein the first frame and the second frame have a common duration.

2. The method of claim 1, wherein each frame in the plurality of frames includes parity bits or transition bits in each lane that indicate a number of data bytes transmitted in the each frame.

3. The method of claim 1, further comprising:
notifying one or more devices of unavailability of an alert opportunity prior to transmitting the first frame; and
notifying the one or more devices that the second frame provides an opportunity to launch an alert after transmission of the second data bytes.

4. The method of claim 3, wherein notifying the one or more devices of unavailability of the alert opportunity comprises:
transmitting a first command code over the serial bus prior to transmitting the first frame.

5. The method of claim 4, wherein notifying the one or more devices that the second frame provides the opportunity to launch the alert comprises:
transmitting a second command code over the serial bus prior to transmitting the first frame, the second command code being different from the first command code.

6. The method of claim 5, wherein transmitting the second command code comprises:
determining a total number of bytes transmitted after the first command code has been transmitted; and
transmitting the second command code when the total number of bytes transmitted after the first command code is at least equal to a configured maximum number of bytes between alert opportunities.

7. The method of claim 3, wherein the opportunity to launch the alert after transmission of the second data bytes is provided when no bit is transmitted on a data lane used by a device that is configured for communicating over a 2-line serial bus.

8. The method of claim 3, further comprising:
detecting the alert launched by one of the one or more devices after transmission of the second data bytes; and
terminating transmission over the serial bus in response to the alert.

9. The method of claim 1, wherein the serial bus includes at least 2 data lanes.

10. The method of claim 1, wherein each frame is configured to stripe each byte across at least 2 data lanes.

11. An apparatus, comprising:
a bus interface configured to couple the apparatus to a multi-lane serial bus;
a first control register configured with a fairness value; and
I3C logic having a byte counter, the I3C logic being configured to cause the bus interface to:
transmit a first command code over the multi-lane serial bus;
transmit a plurality of frames over the multi-lane serial bus; and
transmit a second command code over the multi-lane serial bus after the byte counter indicates that a number of bytes transmitted since transmission of the first command code is at least equal to the fairness value,
wherein the first command code is configured to restrain one or more devices coupled to the multi-lane serial bus from launching an alert over the multi-lane serial bus, and
wherein the second command code is configured to notify the one or more devices of an opportunity to launch an alert over the multi-lane serial bus.

12. The apparatus of claim 11, wherein the I3C logic is further configured to cause the bus interface to:
transmit at least one unfilled frame over the multi-lane serial bus after transmitting the second command code.

13. An apparatus comprising:
a serial bus;
means for providing a plurality of frames, each frame being configured to carry up to a maximum number of data bytes;
means for transmitting frames over the serial bus, wherein a first frame transmitted over the serial bus is filled with first data bytes and a second frame transmitted over the serial bus includes second data bytes less in number than the maximum number of data bytes;
means for notifying one or more devices of unavailability of an alert opportunity prior to transmitting the first frame; and
means for notifying the one or more devices that the second frame provides an opportunity to launch an alert after transmission of the second data bytes.

14. The apparatus of claim 13, wherein the means for notifying the one or more devices of unavailability of the alert opportunity is configured to:
transmit a first command code over the serial bus prior to transmitting the first frame.

15. The apparatus of claim 14, wherein the means for notifying the one or more devices that the second frame provides the opportunity to launch the alert is configured to:
transmit a second command code over the serial bus prior to transmitting the first frame, the second command code being different from the first command code.

16. The apparatus of claim 15, wherein the second command code is transmitted by:
determining a total number of bytes transmitted after the first command code has been transmitted; and
transmitting the second command code when the total number of bytes transmitted after the first command code is at least equal to a configured maximum number of bytes between alert opportunities.

17. The apparatus of claim 13, wherein the serial bus includes at least 2 data lanes.

18. The apparatus of claim 13, wherein each frame is configured to stripe each byte across at least 2 data lanes.

19. The apparatus of claim 13, wherein the opportunity to launch the alert after transmission of the second data bytes is provided when no bit is transmitted on a data lane used by a device that is configured for communicating over a 2-line serial bus.

20. The apparatus of claim 13, further comprising:
means for detecting the alert launched by one of the one or more devices after transmission of the second data bytes, wherein a transmission over the serial bus is terminated in response to the alert.

21. A processor-readable storage medium comprising instructions for:
providing a plurality of frames, each frame being configured to carry up to a maximum number of data bytes;
transmitting a first frame over a serial bus, wherein the first frame is filled with first data bytes; and
transmitting a second frame over the serial bus, wherein the second frame includes second data bytes less in number than the maximum number of data bytes, and wherein the first frame and the second frame have a common duration.

22. The processor-readable storage medium of claim 21, wherein each frame in the plurality of frames includes parity bits or transition bits in each lane that indicate a number of data bytes transmitted in the each frame.

23. The processor-readable storage medium of claim 21, further comprising instructions for:
notifying one or more devices of unavailability of an alert opportunity prior to transmitting the first frame; and
notifying the one or more devices that the second frame provides an opportunity to launch an alert after transmission of the second data bytes.

24. The processor-readable storage medium of claim 23, further comprising instructions for:
transmitting a first command code over the serial bus prior to transmitting the first frame.

25. The processor-readable storage medium of claim 24, further comprising instructions for:
transmitting a second command code over the serial bus prior to transmitting the first frame, the second command code being different from the first command code.

26. The processor-readable storage medium of claim 25, further comprising instructions for:
determining a total number of bytes transmitted after the first command code has been transmitted; and
transmitting the second command code when the total number of bytes transmitted after the first command code is at least equal to a configured maximum number of bytes between alert opportunities.

27. The processor-readable storage medium of claim 23, wherein the opportunity to launch the alert after transmission of the second data bytes is provided when no bit is transmitted on a data lane used by a device that is configured for communicating over a 2-line serial bus.

28. The processor-readable storage medium of claim 23, further comprising instructions for:
detecting the alert launched by one of the one or more devices after transmission of the second data bytes; and
terminating transmission over the serial bus in response to the alert.

29. The processor-readable storage medium of claim 21, wherein the serial bus includes at least 2 data lanes.

30. The processor-readable storage medium of claim 21, wherein each frame is configured to stripe each byte across at least 2 data lanes.
